(19) United States
(12) Patent Application Publication
(10) Pub. No.: US 2025/0088335 A1
(43) Pub. Date: Mar. 13, 2025

(54) METHOD AND APPARATUS FOR TRANSCEIVING HARQ-ACK INFORMATION IN WIRELESS COMMUNICATION SYSTEM

(71) Applicant: SAMSUNG ELECTRONICS CO., LTD., Suwon-si, Gyeonggi-do (KR)

(72) Inventors: Sa ZHANG, Beijing (CN); Feifei SUN, Beijing (CN)

(21) Appl. No.: 18/727,044

(22) PCT Filed: Jan. 6, 2023
(86) PCT No.: PCT/KR2023/000300

§ 371 Date: Jul. 5, 2024

(30) Foreign Application Priority Data
Jan. 7, 2022 (CN) 202210016316.4
Jan. 10, 2022 (CN) 202210023410.2
Nov. 10, 2022 (CN) 202211406895.X

(51) Int. Cl. H04L 5/00; H04W 72/0446

(52) U.S. Cl. CPC H04L 5/0055; H04W 72/0446

(57) ABSTRACT

The disclosure relates to a 5G or 6G communication system for supporting a higher data transmission rate. A terminal and a method performed by the same in a wireless communication system are provided. The method includes transmitting a physical uplink shared channel (PUSCH) and/or receiving a physical downlink shared channel (PDSCH) from one or more PUSCHs and/or one or more PDSCHs, wherein the one or more PUSCHs include dynamically scheduled PUSCHs and/or configured grant (CG) PUSCHs, and the one or more PDSCHs include dynamically scheduled PDSCHs and/or semi-persistent scheduling (SPS) PDSCHs. The invention can improve communication efficiency.

### TECHNICAL FIELD

The disclosure relates a wireless communication (or, a mobile communication system). More particularly, the disclosure relates to a terminal and a method performed by the same in a wireless communication system (or, a mobile communication system).

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

There are needs to enhance procedures of transmission and reception of HARQ-ACK (hybrid automatic repeat request acknowledgement) information.

### Solution to Problem

According to an embodiment of the disclosure, a method performed by a terminal is provided. The method comprises receiving, from a base station, first information configuring a time domain allocation list for multiple physical downlink shared channels (PDSCHs) and second information enabling a time domain hybrid automatic repeat request (HARQ) bundling; receiving, from the base station, a plurality of PDSCHs; and transmitting, to the base station, a HARQ acknowledgement (HARQ-ACK) codebook for the plurality of PDSCHs based on the first information and the second information, wherein, in case that each slot of the plurality of PDSCHs includes an uplink symbol of a PDSCH time resource, a time domain resource allocation set for the HARQ-ACK codebook is updated based on a row index corresponding to the PDSCH time resource.

According to an embodiment of the disclosure, a terminal is provided. The terminal comprises a transceiver; and a controller coupled with the transceiver and configured to: receive, from a base station, first information configuring a time domain allocation list for multiple physical downlink shared channels (PDSCHs) and second information enabling a time domain hybrid automatic repeat request (HARQ) bundling, receive, from the base station, a plurality of PDSCHs, and transmit, to the base station, a HARQ acknowledgement (HARQ-ACK) codebook for the plurality of PDSCHs based on the first information and the second information, wherein, in case that each slot of the plurality of PDSCHs includes an uplink symbol of a PDSCH time resource, a time domain resource allocation set for the HARQ-ACK codebook is updated based on a row index corresponding to the PDSCH time resource.

According to an embodiment of the disclosure, a method performed by a base station is provided. The method comprises transmitting, to a terminal, first information configuring a time domain allocation list for multiple physical downlink shared channels (PDSCHs) and second information enabling a time domain hybrid automatic repeat request (HARQ) bundling; transmitting, to the terminal, a plurality of PDSCHs; and receiving, from the terminal, a HARQ acknowledgement (HARQ-ACK) codebook for the plurality of PDSCHs based on the first information and the second information, wherein, in case that each slot of the plurality of PDSCHs includes an uplink symbol of a PDSCH time resource, a time domain resource allocation set for the HARQ-ACK codebook is updated based on a row index corresponding to the PDSCH time resource.

According to an embodiment of the disclosure, a base station is provided. The base station comprises a transceiver; and
a controller coupled with the transceiver and configured to: transmit, to a terminal, first information configuring a time domain allocation list for multiple physical downlink shared channels (PDSCHs) and second information enabling a time domain hybrid automatic repeat request (HARQ) bundling, transmit, to the terminal, a plurality of PDSCHs, and receive, from the terminal, a HARQ acknowledgement (HARQ-ACK) codebook for the plurality of PDSCHs based on the first information and the second information, wherein, in case that each slot of the plurality of PDSCHs includes an uplink symbol of a PDSCH time resource, a time domain resource allocation set for the HARQ-ACK codebook is updated based on a row index corresponding to the PDSCH time resource.

### Advantageous Effects of Invention

According to various embodiments of the disclosure, procedures regarding transmitting and receiving of HARQ-Ack information can be efficiently enhanced.

### BRIEF DESCRIPTION OF DRAWINGS

In order to illustrate the technical schemes of the embodiments of the disclosure more clearly, the drawings of the embodiments of the disclosure will be briefly introduced below. Apparently, the drawings described below only refer to some embodiments of the disclosure, and do not limit the disclosure. In the drawings:

FIG. 1 illustrates a schematic diagram of an example wireless network according to some embodiments of the disclosure;

FIG. 2A illustrates an example wireless transmission and reception paths according to some embodiments of the disclosure;

FIG. 2B illustrates an example wireless transmission and reception paths according to some embodiments of the disclosure;

FIG. 3A illustrates an example user equipment (UE) according to some embodiments of the disclosure;

FIG. 3B illustrates an example gNB according to some embodiments of the disclosure;

FIG. 4 illustrates a block diagram of a second transceiving node according to some embodiments of the disclosure;

FIG. 5 illustrates a flowchart of a method performed by a UE according to some embodiments of the disclosure;

FIG. 6A illustrates some examples of uplink transmission timing according to some embodiments of the disclosure;

FIG. 6B illustrates some examples of uplink transmission timing according to some embodiments of the disclosure;

FIG. 6C illustrates some examples of uplink transmission timing according to some embodiments of the disclosure;

FIG. 7A illustrates examples of time domain resource allocation tables (TDRAs) according to some embodiments of the disclosure;

FIG. 7B illustrates examples of TDRAs according to some embodiments of the disclosure;

FIG. 8 illustrates a flowchart of a method performed by a terminal according to some embodiments of the disclosure;

FIG. 9 illustrates a block diagram of a first transceiving node according to some embodiments of the disclosure;

FIG. 10 illustrates a flowchart of a method performed by a base station according to some embodiments of the disclosure;

FIG. 11 illustrates a block diagram of a terminal (or a user equipment (UE)) according to an embodiment of the disclosure; and

FIG. 12 illustrates a block diagram of a base station according to an embodiment of the disclosure.

### BEST MODE FOR CARRYING OUT THE INVENTION

In order to make the purpose, technical schemes and advantages of the embodiments of the disclosure clearer, the technical schemes of the embodiments of the disclosure will be described clearly and completely with reference to the drawings of the embodiments of the disclosure. Apparently, the described embodiments are a part of the embodiments of the disclosure, but not all embodiments. Based on the described embodiments of the disclosure, all other embodiments obtained by those of ordinary skill in the art without creative labor belong to the protection scope of the disclosure.

Before undertaking the DETAILED DESCRIPTION below, it can be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, connect to, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller can be implemented in hardware or a combination of hardware and software and/or firmware. The functionality associated with any particular controller can be centralized or distributed, whether locally or remotely. The phrase “at least one of,” when used with a list of items, means that different combinations of one or more of the listed items can be used, and only one item in the list can be needed. For example, “at least one of: A, B, and C” includes any of the following combinations: A, B, C, A and B, A and C, B and C, and A and B and C. For example, “at least one of: A, B, or C” includes any of the following combinations: A, B, C, A and B, A and C, B and C, and A, B and C.

Moreover, various functions described below can be implemented or supported by one or more computer programs, each of which is formed from computer-readable program code and embodied in a computer-readable medium. The terms “application” and “program” refer to one or more computer programs, software components, sets of instructions, procedures, functions, objects, classes, instances, related data, or a portion thereof adapted for implementation in a suitable computer-readable program code. The phrase “computer-readable program code” includes any type of computer code, including source code, object code, and executable code. The phrase “computer-readable medium” includes any type of medium capable of being accessed by a computer, such as Read-Only Memory (ROM), Random Access Memory (RAM), a hard disk drive, a Compact Disc (CD), a Digital Video Disc (DVD), or any other type of memory. A “non-transitory” computer-readable medium excludes wired, wireless, optical, or other communication links that transport transitory electrical or other signals. A non-transitory computer-readable medium includes media where data can be permanently stored and media where data can be stored and later overwritten, such as a rewritable optical disc or an erasable memory device.

Terms used herein to describe the embodiments of the disclosure are not intended to limit and/or define the scope of the present invention. For example, unless otherwise defined, the technical terms or scientific terms used in the disclosure shall have the ordinary meaning understood by those with ordinary skills in the art to which the present invention belongs.

It should be understood that “first”, “second” and similar words used in the disclosure do not express any order, quantity or importance, but are only used to distinguish different components. Similar words such as singular forms “a”, “an” or “the” do not express a limitation of quantity, but express the existence of at least one of the referenced item, unless the context clearly dictates otherwise. For example, reference to “a component surface” includes reference to one or more of such surfaces.

As used herein, any reference to “an example” or “example”, “an implementation” or “implementation”, “an embodiment” or “embodiment” means that particular elements, features, structures or characteristics described in connection with the embodiment is included in at least one embodiment. The phrases “in one embodiment” or “in one example” appearing in different places in the specification do not necessarily refer to the same embodiment.

As used herein, “a portion of” something means “at least some of” the thing, and as such may mean less than all of, or all of, the thing. As such, “a portion of” a thing includes the entire thing as a special case, i.e., the entire thing is an example of a portion of the thing.

As used herein, the term “set” means one or more. Accordingly, a set of items can be a single item or a collection of two or more items.

In this disclosure, to determine whether a specific condition is satisfied or fulfilled, expressions, such as “greater than” or “less than” are used by way of example and expressions, such as “greater than or equal to” or “less than or equal to” are also applicable and not excluded. For example, a condition defined with “greater than or equal to” may be replaced by “greater than” (or vice-versa), a condition defined with “less than or equal to” may be replaced by “less than” (or vice-versa), etc.

It will be further understood that similar words such as the term “include” or “comprise” mean that elements or objects appearing before the word encompass the listed elements or objects appearing after the word and their equivalents, but other elements or objects are not excluded. Similar words such as “connect” or “connected” are not limited to physical or mechanical connection, but can include electrical connection, whether direct or indirect. “Upper”, “lower”, “left” and “right” are only used to express a relative positional relationship, and when an absolute position of the described object changes, the relative positional relationship may change accordingly.

The various embodiments discussed below for describing the principles of the disclosure in the patent document are for illustration only and should not be interpreted as limiting the scope of the disclosure in any way. Those skilled in the art will understand that the principles of the disclosure can be implemented in any suitably arranged wireless communication system. For example, although the following detailed description of the embodiments of the disclosure will be directed to LTE and/or 5G communication systems, those skilled in the art will understand that the main points of the disclosure can also be applied to other communication systems with similar technical backgrounds and channel formats with slight modifications without departing from the scope of the disclosure. The technical schemes of the embodiments of the present application can be applied to various communication systems, and for example, the communication systems may include global systems for mobile communications (GSM), code division multiple access (CDMA) systems, wideband code division multiple access (WCDMA) systems, general packet radio service (GPRS) systems, long term evolution (LTE) systems, LTE frequency division duplex (FDD) systems, LTE time division duplex (TDD) systems, universal mobile telecommunications system (UMTS), worldwide interoperability for microwave access (WiMAX) communication systems, 5th generation (5G) systems or new radio (NR) systems, etc. In addition, the technical schemes of the embodiments of the present application can be applied to future-oriented communication technologies. In addition, the technical schemes of the embodiments of the present application can be applied to future-oriented communication technologies.

Hereinafter, the embodiments of the disclosure will be described in detail with reference to the accompanying drawings. It should be noted that the same reference numerals in different drawings will be used to refer to the same elements already described.

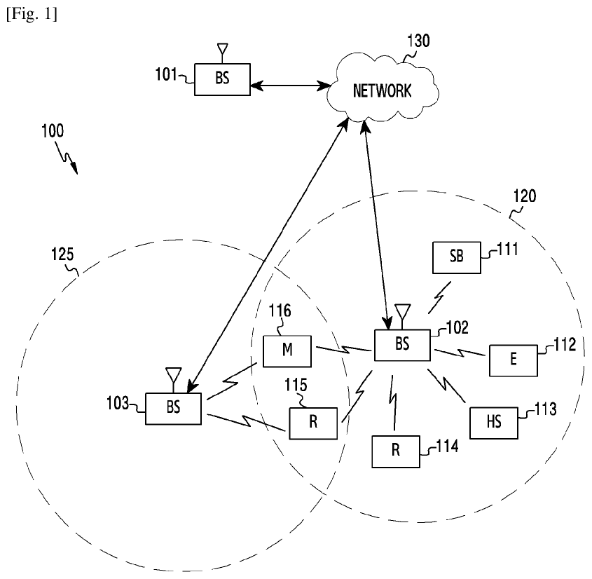

The following FIGS. 1-3B describe various embodiments implemented by using orthogonal frequency division multiplexing (OFDM) or orthogonal frequency division multiple access (OFDMA) communication technologies in wireless communication systems. The descriptions of FIGS. 1-3B do not mean physical or architectural implications for the manner in which different embodiments may be implemented. Different embodiments of the disclosure may be implemented in any suitably arranged communication systems.

FIG. 1 illustrates an example wireless network 100 according to some embodiments of the disclosure. The embodiment of the wireless network 100 shown in FIG. 1 is for illustration only. Other embodiments of the wireless network 100 can be used without departing from the scope of the disclosure.

The wireless network 100 includes a gNodeB (gNB) 101, a gNB 102, and a gNB 103. gNB 101 communicates with gNB 102 and gNB 103. gNB 101 also communicates with at least one Internet Protocol (IP) network 130, such as the Internet, a private IP network, or other data networks.

Depending on a type of the network, other well-known terms such as “base station (BS)” or “access point” can be used instead of “gNodeB” or “gNB”. For convenience, the terms “gNodeB” and “gNB” are used in this patent document to refer to network infrastructure components that provide wireless access for remote terminals. And, depending on the type of the network, other well-known terms such as “mobile station”, “user station”, “remote terminal”, “wireless terminal” or “user apparatus” can be used instead of “user equipment” or “UE”. For example, the terms “terminal”, “user equipment” and “UE” may be used in this patent document to refer to remote wireless devices that wirelessly access the gNB, no matter whether the UE is a mobile device (such as a mobile phone or a smart phone) or a fixed device (such as a desktop computer or a vending machine).

gNB 102 provides wireless broadband access to the network 130 for a first plurality of User Equipments (UEs) within a coverage area 120 of gNB 102. The first plurality of UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. GNB 103 provides wireless broadband access to network 130 for a second plurality of UEs within a coverage area 125 of gNB 103. The second plurality of UEs include a UE 115 and a UE 116. In some embodiments, one or more of gNBs 101-103 can communicate with each other and with UEs 111-116 using 5G, Long Term Evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a 2D antenna array as described in embodiments of the disclosure. In some embodiments, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

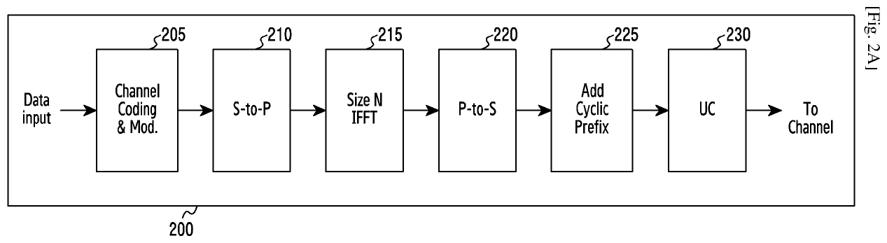

FIGS. 2A and 2B illustrate example wireless transmission and reception paths according to some embodiments of the disclosure. In the following description, the transmission path 200 can be described as being implemented in a gNB, such as gNB 102, and the reception path 250 can be described as being implemented in a UE, such as UE 116. However, it should be understood that the reception path 250 can be implemented in a gNB and the transmission path 200 can be implemented in a UE. In some embodiments, the reception path 250 is configured to support codebook designs and structures for systems with 2D antenna arrays as described in embodiments of the disclosure.

The transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. The reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. The Serial-to-Parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time domain output signal. The Parallel-to-Serial block 220 converts (such as multiplexes) parallel time domain output symbols from the Size N IFFT block 215 to generate a serial time domain signal. The cyclic prefix addition block 225 inserts a cyclic prefix into the time domain signal. The up-converter 230 modulates (such as up-converts) the output of the cyclic prefix addition block 225 to an RF frequency for transmission via a wireless channel. The signal can also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time domain baseband signal. The Serial-to-Parallel block 265 converts the time domain baseband signal into a parallel time domain signal. The Size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2A and 2B can be implemented using only hardware, or using a combination of hardware and software/firmware. As a specific example, at least some of the components in FIGS. 2A and 2B may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the disclosure. Other types of transforms can be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2A and 2B illustrate examples of wireless transmission and reception paths, various changes may be made to FIGS. 2A and 2B. For example, various components in FIGS. 2A and 2B can be combined, further subdivided or omitted, and additional components can be added according to specific requirements. Furthermore, FIGS. 2A and 2B are intended to illustrate examples of types of transmission and reception paths that can be used in a wireless network. Any other suitable architecture can be used to support wireless communication in a wireless network.

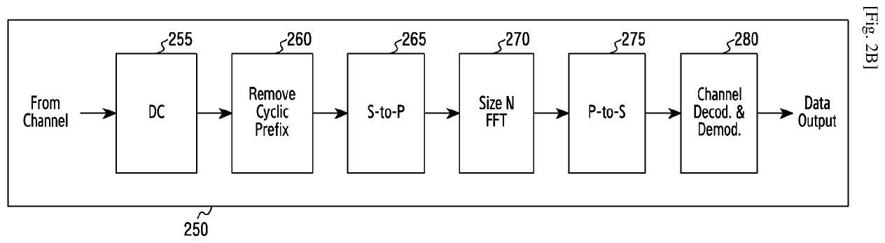

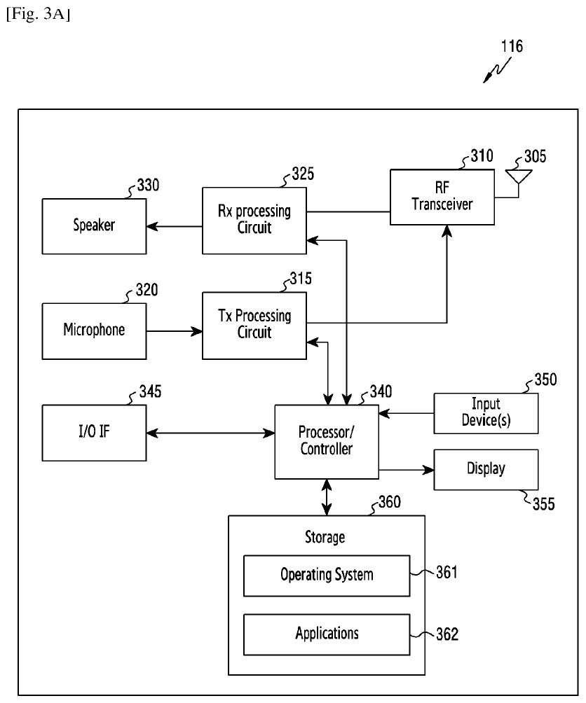

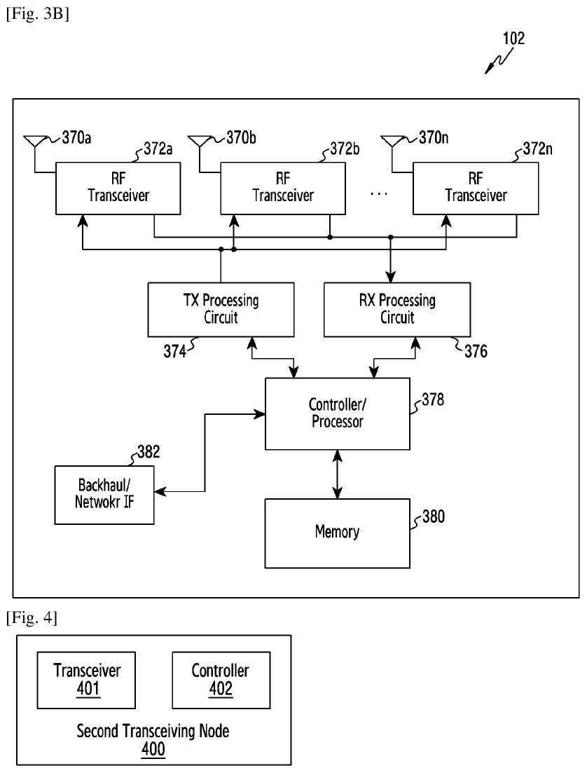

FIG. 3A illustrates an example UE 116 according to the disclosure. The embodiment of UE 116 shown in FIG. 3A is for illustration only, and UEs 111-115 of FIG. 1 can have the same or similar configuration. However, a UE has various configurations, and FIG. 3A does not limit the scope of the disclosure to any specific implementation of the UE.

UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the disclosure. The processor/controller 340 can move data into or out of the memory 360 as required by an execution process. In some embodiments, the processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3A illustrates an example of UE 116, various changes can be made to FIG. 3A. For example, various components in FIG. 3A can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3A illustrates that the UE 116 is configured as a mobile phone or a smart phone, UEs can be configured to operate as other types of mobile or fixed devices.

FIG. 3B illustrates an example gNB 102 according to some embodiments of the disclosure. The embodiment of gNB 102 shown in FIG. 3B is for illustration only, and other gNBs of FIG. 1 can have the same or similar configuration. However, a gNB has various configurations, and FIG. 3B does not limit the scope of the disclosure to any specific implementation of a gNB. It should be noted that gNB 101 and gNB 103 can include the same or similar structures as gNB 102.

As shown in FIG. 3B, gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n include a 2D antenna array. gNB 102 also includes a controller/processor 378, a memory 380, and a backhaul or network interface 382. RF transceivers 372a-372n receive an incoming RF signal from antennas 370a-370n, such as a signal transmitted by UEs or other gNBs. RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and up-convert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the disclosure. In some embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 3B illustrates an example of gNB 102, various changes may be made to FIG. 3B. For example, gNB 102 can include any number of each component shown in FIG. 3A. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

Those skilled in the art will understand that, “terminal” and “terminal device” as used herein include not only devices with wireless signal receiver which have no transmitting capability, but also devices with receiving and transmitting hardware which can carry out bidirectional communication on a bidirectional communication link. Such devices may include cellular or other communication devices with single-line displays or multi-line displays or cellular or other communication devices without multi-line displays; a PCS (personal communications service), which may combine voice, data processing, fax and/or data communication capabilities; a PDA (Personal Digital Assistant), which may include a radio frequency receiver, a pager, an internet/intranet access, a web browser, a notepad, a calendar and/or a GPS (Global Positioning System) receiver; a conventional laptop and/or palmtop computer or other devices having and/or including a radio frequency receiver. “Terminal” and “terminal device” as used herein may be portable, transportable, installed in vehicles (aviation, sea transportation and/or land), or suitable and/or configured to operate locally, and/or in distributed form, operate on the earth and/or any other position in space. “Terminal” and “terminal device” as used herein may also be a communication terminal, an internet terminal, a music/video playing terminal, such as a PDA, a MID (Mobile Internet Device) and/or a mobile phone with music/video playing functions, a smart TV, a set-top box and other devices.

With the rapid development of information industry, especially the increasing demand from mobile Internet and internet of things (IoT), it brings unprecedented challenges to the future mobile communication technology. According to the report of International Telecommunication Union (ITU) ITU-R M. (IMT.BEYOND 2020.TRAFFIC), the growth of mobile traffic is nearly 1000 times compared to 2010, and the number of UE connections will also exceed 17 billion, and the number of connected devices will be even more alarming, with the massive IoT devices gradually infiltrating into the mobile communication network. In order to meet the unprecedented challenges, the communication industry and academia have carried out extensive research on the fifth generation (5G) mobile communication technology to face the 2020s. At present in ITU report ITU-R M. (IMT.VISION), the framework and overall goals of the future 5G has been discussed, in which the demand outlook, application scenarios and important performance indicators of 5G are described in detail. With respect to new requirements in 5G, ITU report ITU-R M. (IMT.FUTURE TECHNOLOGY TRENDS) provides information related to the technology trends of 5G, aiming at solving significant problems such as significantly improved system throughput, consistent user experience, scalability to support IoT, delay, energy efficiency, cost, network flexibility, support of emerging services and flexible spectrum utilization.

In 3GPP (3rd Generation Partnership Project), the first stage of 5G is already in progress. To support more flexible scheduling, the 3GPP decides to support variable Hybrid Automatic Repeat request-Acknowledgement (HARQ-ACK) feedback delay in 5G. In existing Long Term Evolution (LTE) systems, a time from reception of downlink data to uplink transmission of HARQ-ACK is fixed. For example, in Frequency Division Duplex (FDD) systems, the delay is 4 subframes. In Time Division Duplex (TDD) systems, a HARQ-ACK feedback delay is determined for a corresponding downlink subframe based on an uplink and downlink configuration. In 5G systems, whether FDD or TDD systems, for a determined downlink time unit (e.g., a downlink slot or a downlink mini slot), the uplink time unit that can feedback HARQ-ACK is variable. For example, the delay of HARQ-ACK feedback can be dynamically indicated by physical layer signaling, or different HARQ-ACK delays can be determined based on factors such as different services or user capabilities.

The 3GPP has defined three directions of 5G application scenarios-eMBB (enhanced mobile broadband), mMTC (massive machine-type communication) and URLLC (ultra-reliable and low-latency communication). The eMBB scenario aims to further improve data transmission rate on the basis of the existing mobile broadband service scenario, so as to enhance user experience and pursue ultimate communication experience between people. mMTC and URLLC are, for example, the application scenarios of the Internet of Things, but their respective emphases are different: mMTC being mainly information interaction between people and things, while URLLC mainly reflecting communication requirements between things.

As described above, various services can be provided according to the development of the wireless communication systems, and thus a method for easily providing such services is required.

In order to solve at least the above technical problems, embodiments of the disclosure provide a method performed by a terminal, the terminal, a method performed by a base station and the base station in a wireless communication system, and a non-transitory computer-readable storage medium. Hereinafter, various embodiments of the disclosure will be described in detail with reference to the accompanying drawings.

In embodiments of the disclosure, for the convenience of description, a first transceiving node and a second transceiving node are defined. For example, the first transceiving node may be a base station, and the second transceiving node may be a UE. In the following examples, the base station is taken as an example (but not limited thereto) to illustrate the first transceiving node, and the UE is taken as an example (but not limited thereto) to illustrate the second transceiving node.

Exemplary embodiments of the disclosure are further described below with reference to the drawings.

The text and drawings are provided as examples only to help readers understand the disclosure. They are not intended and should not be interpreted as limiting the scope of the disclosure in any way. Although certain embodiments and examples have been provided, based on the content disclosed herein, it will be apparent to those skilled in the art that changes may be made to the illustrated embodiments and examples without departing from the scope of the disclosure.

FIG. 4 illustrates a block diagram of the second transceiving node according to an embodiment of the disclosure.

Referring to FIG. 4, the second transceiving node 400 may include a transceiver 401 and a controller 402.

The transceiver 401 may be configured to receive first data and/or first control signaling from the first transceiving node, and transmit second data and/or second control signaling to the first transceiving node in a determined time unit.

The controller 402 may be an application specific integrated circuit or at least one processor. The controller 402 may be configured to control the overall operation of the second transceiving node and control the second transceiving node to implement the methods proposed in the embodiments of the disclosure. For example, the controller 402 may be configured to determine the second data and/or the second control signaling and a time unit for transmitting the second data and/or the second control signaling based on the first data and/or the first control signaling, and control the transceiver 401 to transmit the second data and/or the second control signaling to the first transceiving node in the determined time unit.

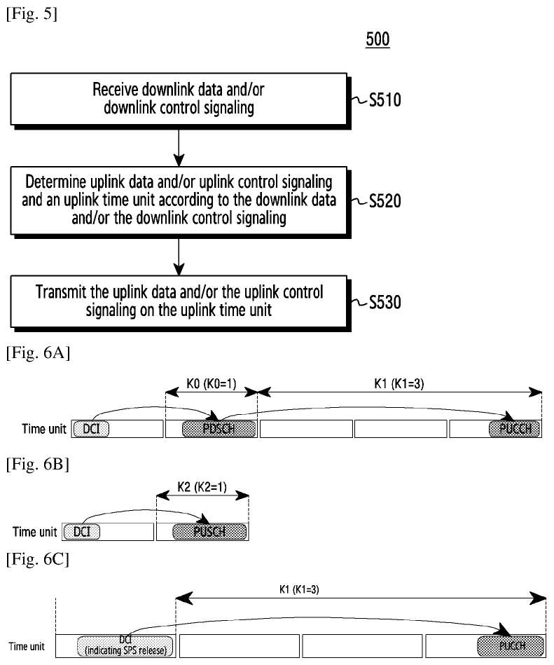

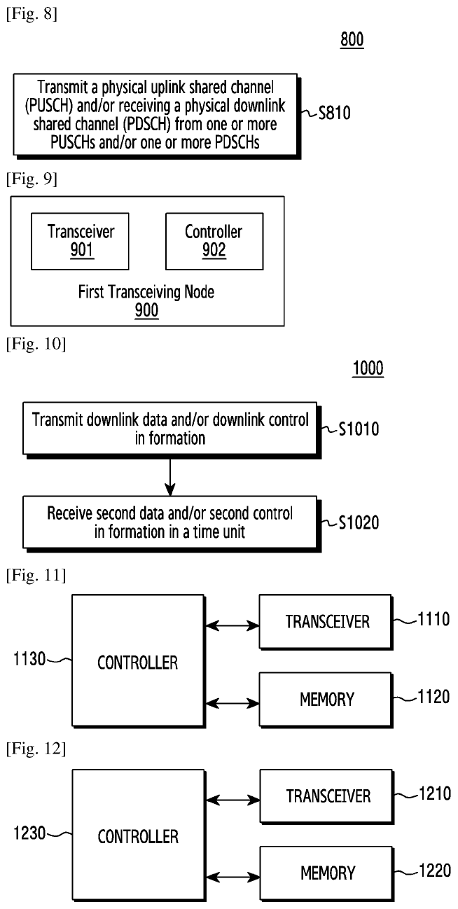

In some implementations, the controller 402 may be configured to perform one or more operations in methods of various embodiments described below. For example, the controller 402 may be configured to perform one or more of operations in a method 500 to be described later in connection with FIG. 5 and/or a method 800 described in connection with FIG. 8.

In some implementations, the first data may be data transmitted by the first transceiving node to the second transceiving node. In the following examples, downlink data carried by a PDSCH (Physical Downlink Shared Channel) is taken as an example (but not limited thereto) to illustrate the first data.

In some implementations, the second data may be data transmitted by the second transceiving node to the first transceiving node. In the following examples, uplink data carried by a PUSCH (Physical Uplink Shared Channel) is taken as an example to illustrate the second data, but not limited thereto.

In some implementations, the first control signaling may be control signaling transmitted by the first transceiving node to the second transceiving node. In the following examples, downlink control signaling is taken as an example (but not limited thereto) to illustrate the first control signaling. The downlink control signaling may be DCI (downlink control information) carried by a PDCCH (Physical Downlink Control Channel) and/or control signaling carried by a PDSCH (Physical Downlink Shared Channel). For example, the DCI may be UE specific DCI, and the DCI may also be common DCI. The common DCI may be DCI common to a part of UEs, such as group common DCI, and the common DCI may also be DCI common to all of the UEs. The DCI may be uplink DCI (e.g., DCI for scheduling a PUSCH) and/or downlink DCI (e.g., DCI for scheduling a PDSCH).

In some implementations, the second control signaling may be control signaling transmitted by the second transceiving node to the first transceiving node. In the following examples, uplink control signaling is taken as an example (but is not limited thereto) to illustrate the second control signaling. The uplink control signaling may be UCI (Uplink Control Information) carried by a PUCCH (Physical Uplink Control Channel) and/or control signaling carried by a PUSCH (Physical Uplink Shared Channel). A type of UCI may include one or more of: HARQ-ACK information, SR (Scheduling Request), LRR (Link Recovery Request), CSI (Chanel State Information) or CG (Configured Grant) UCI. In embodiments of the disclosure, when UCI is carried by a PUCCH, the UCI may be used interchangeably with the PUCCH.

In some implementations, a PUCCH with SR may be a PUCCH with positive SR and/or negative SR. The SR may be the positive SR and/or the negative SR.

In some implementations, the CSI may also be Part 1 CSI and/or Part 2 CSI.

In some implementations, a first time unit is a time unit in which the first transceiving node transmits the first data and/or the first control signaling. In the following examples, a downlink time unit is taken as an example (but not limited thereto) to illustrate the first time unit.

In some implementations, a second time unit is a time unit in which the second transceiving node transmits the second data and/or the second control signaling. In the following examples, an uplink time unit is taken as an example (but not limited thereto) to illustrate the second time unit.

In some implementations, the first time unit and the second time unit may be one or more slots, one or more subslots, one or more OFDM symbols, or one or more subframes.

Herein, depending on the network type, the term “base station” or “BS” can refer to any component (or a set of components) configured to provide wireless access to a network, such as a Transmission Point (TP), a Transmission and Reception Point (TRP), an evolved base station (eNodeB or eNB), a 5G base station (gNB), a macrocell, a femtocell, a WiFi access point (AP), or other wirelessly enabled devices. Base stations may provide wireless access in accordance with one or more wireless communication protocols, e.g., 5G 3GPP new radio (NR) interface/access, Long Term Evolution (LTE), LTE advanced (LTE-A), High Speed Packet Access (HSPA), Wi-Fi 802.11a/b/g/n/ac, etc.

In describing a wireless communication system and in the disclosure described below, higher layer signaling or higher layer signals may be signal transferring methods for transferring information from a base station to a terminal over a downlink data channel of a physical layer or from a terminal to a base station over an uplink data channel of a physical layer, and examples of the signal transferring methods may include signal transferring methods for transferring information via Radio Resource Control (RRC) signaling, Packet Data Convergence Protocol (PDCP) signaling, or a Medium Access Control (MAC) Control Element (MAC CE).

FIG. 5 illustrates a flowchart of a method performed by a UE according to embodiments of the disclosure.

Referring to FIG. 5, in step S510, the UE may receive downlink data (e.g., downlink data carried by a PDSCH) and/or downlink control signaling from a base station. For example, the UE may receive the downlink data and/or the downlink control signaling from the base station based on predefined rules and/or received configuration parameters.

In step S520, the UE determines uplink data and/or uplink control signaling and an uplink time unit based on the downlink data and/or downlink control signaling.

In step S530, the UE transmits the uplink data and/or the uplink control signaling to the base station in an uplink time unit.

In some implementations, acknowledgement/negative acknowledgement (ACK/NACK) for downlink transmissions may be performed through HARQ-ACK.

In some implementations, the downlink control signaling may include DCI carried by a PDCCH and/or control signaling carried by a PDSCH. For example, the DCI may be used to schedule transmission of a PUSCH or reception of a PDSCH. Some examples of uplink transmission timing will be described below with reference to FIGS. 6A-6C.

In an example, the UE receives the DCI and receives the PDSCH based on time domain resources indicated by the DCI. For example, a parameter K0 may be used to represent a time interval between the PDSCH scheduled by the DCI and the PDCCH carrying the DCI, and K0 may be in units of slots. For example, FIG. 6A gives an example in which K0=1. In the example illustrated in FIG. 6A, the time interval from the PDSCH scheduled by the DCI to the PDCCH carrying the DCI is one slot. In embodiments of the disclosure, “a UE receives DCI” may be understood as “the UE detects the DCI”

In another example, the UE receives the DCI and transmits the PUSCH based on time domain resources indicated by the DCI. For example, a timing parameter K2 may be used to represent a time interval between the PUSCH scheduled by the DCI and the PDCCH carrying the DCI, and K2 may be in units of slots. For example, FIG. 6B gives an example in which K2=1. In the example illustrated in FIG. 6B, the time interval between the PUSCH scheduled by the DCI and the PDCCH carrying the DCI is one slot. K2 may also represent a time interval between a PDCCH for activating a CG (configured grant) PUSCH and the first activated CG PUSCH. In examples of the disclosure, unless otherwise specified, the PUSCH may be a dynamically scheduled PUSCH (e.g., scheduled by DCI) (e.g., may be referred to as DG (dynamic grant) PUSCH, in embodiments of the disclosure) and/or a PUSCH not scheduled by DCI (e.g., CG PUSCH).

In yet another example, the UE receives the PDSCH, and may transmit HARQ-ACK information for the PDSCH in a PUCCH in the uplink time unit. For example, a timing parameter (which may also be referred to as a timing value) K1 (e.g., the parameter dl-DataToUL-ACK in 3GPP) may be used to represent a time interval between the PUCCH for transmitting the HARQ-ACK information for the PDSCH and the PDSCH, and K1 may be in units of uplink time units, such as slots or subslots. In a case where K1 is in units of slots, the time interval is a value of a slot offset between the PUCCH for feeding back the HARQ-ACK information for the PDSCH and the PDSCH, and K1 may be referred to as a slot timing value. For example, FIG. 6A gives an example in which K1=3. In the example illustrated in FIG. 6A, the time interval between the PUCCH for transmitting the HARQ-ACK information for the PDSCH and the PDSCH is 3 slots. It should be noted that in embodiments of the disclosure, the timing parameter K1 may be used interchangeably with a timing parameter K1, the timing parameter K0 may be used interchangeably with a timing parameter K0, and the timing parameter K2 may be used interchangeably with a timing parameter K2.

In examples of the disclosure, the PDSCH may be a PDSCH scheduled by the DCI and/or a SPS PDSCH. The UE will periodically receive the SPS PDSCH after the SPS PDSCH is activated by the DCI. In examples of the disclosure, the SPS PDSCH may be equivalent to a PDSCH not scheduled by the DCI/PDCCH, or a PDSCH without an associated PDCCH transmission. After the SPS PDSCH is released (deactivated), the UE will no longer receive the SPS PDSCH.

In embodiments of the disclosure, HARQ-ACK may be HARQ-ACK for a SPS PDSCH reception (e.g., HARQ-ACK not indicated by DCI) and/or HARQ-ACK indicated by a DCI format (e.g., HARQ-ACK for a PDSCH scheduled by a DCI format).

In yet another example, the UE receives the DCI (e.g., DCI indicating SPS (Semi-Persistent Scheduling) PDSCH release (deactivation)), and may transmit HARQ-ACK information for the DCI in the PUCCH in the uplink time unit. For example, the timing parameter K1 may be used to represent a time interval between the PUCCH for transmitting the HARQ-ACK information for the DCI and the DCI, and K1 may be in units of uplink time units, such as slots or subslots. For example, FIG. 6C gives an example in which K1=3. In the example of FIG. 6C, the time interval between the PUCCH for transmitting the HARQ-ACK information for the DCI and the DCI is 3 slots. For example, the timing parameter K1 may be used to represent a time interval between a PDCCH reception carrying DCI indicating SPS PDSCH release (deactivation) and the PUCCH feeding back HARQ-ACK for the PDCCH reception.

In some implementations, in step S520, the UE may report (or signal/transmit) a UE capability to the base station or indicate the UE capability. For example, the UE reports (or signals/transmits) the UE capability to the base station by transmitting the PUSCH. In this case, the UE capability information is included in the PUSCH transmitted by the UE.

In some implementations, the base station may configure higher layer signaling for the UE based on a UE capability previously received from the UE (e.g., in step S510 in the previous downlink-uplink transmission processes). For example, the base station configures the higher layer signaling for the UE by transmitting the PDSCH. In this case, the higher layer signaling configured for the UE is included in the PDSCH transmitted by the base station. It should be noted that the higher layer signaling is higher layer signaling compared with physical layer signaling, and the higher layer signaling may include RRC signaling and/or a MAC CE.

In some implementations, downlink channels (downlink resources) may include PDCCHs and/or PDSCHs. Uplink channels (uplink resources) may include PUCCHs and/or PUSCHs.

In some implementations, the UE may be configured with two levels of priorities for uplink transmission. For example, the two levels of priorities may include a first priority and a second priority which are different from each other. In an example, the first priority may be higher than the second priority. In another example, the first priority may be lower than the second priority. However, embodiments of the disclosure are not limited to this, and for example, the UE may be configured with more than two levels of priorities. For the sake of convenience, in embodiments of the disclosure, description will be made considering that the first priority is higher than the second priority. It should be noted that all embodiments of the disclosure are applicable to situations where the first priority may be higher than the second priority; all embodiments of the disclosure are applicable to situations where the first priority may be lower than the second priority; and all embodiments of the disclosure are applicable to situations where the first priority may be equal to the second priority.

In some implementations, the UE may be configured with a subslot-based PUCCH transmission. For example, a subslot length parameter (which may also be referred to as a parameter with respect to a subslot length in embodiments of the disclosure) (e.g., the parameter subslotLengthForPUCCH in 3GPP) of each PUCCH configuration parameter of the first PUCCH configuration parameter and the second PUCCH configuration parameter may be 7 OFDM symbols or 6 OFDM symbols or 2 OFDM symbols. Subslot configuration length parameters in different PUCCH configuration parameters may be configured separately. If no subslot length parameter is configured in a PUCCH configuration parameter, the scheduling time unit of this PUCCH configuration parameter is one slot by default. If a subslot length parameter is configured in the PUCCH configuration parameter, the scheduling time unit of this PUCCH configuration parameter is L (L is the configured subslot configuration length) OFDM symbols.

The mechanism of slot-based PUCCH transmissions is basically the same as that of subslot-based PUCCH transmissions. In the disclosure, a slot may be used to represent a PUCCH occasion unit; for example, if the UE is configured with subslots, a slot which is a PUCCH occasion unit may be replaced with a subslot. For example, it may be specified by protocols that if the UE is configured with the subslot length parameter (e.g., the parameter subslotLengthForPUCCH in 3GPP), unless otherwise indicated, a number of symbols contained in the slot of the PUCCH transmission is indicated by the subslot length parameter.

For example, if the UE is configured with the subslot length parameter, and subslot n is the last uplink subslot overlapping with a PDSCH reception or PDCCH reception (e.g., SPS PDSCH release, and/or indicating secondary cell dormancy, and/or triggering a Type-3 HARQ-ACK codebook report and without scheduling a PDSCH reception), then HARQ-ACK information for the PDSCH reception or PDCCH reception is transmitted in an uplink subslot n+k, where k is determined by the timing parameter K1 (the definition of the timing parameter K1 may refer to the previous description). For another example, if the UE is not configured with the subslot length parameter, and slot n is the last uplink slot overlapping with a downlink slot where the PDSCH reception or PDCCH reception is located, then the HARQ-ACK information for the PDSCH reception or PDCCH reception is transmitted in an uplink slot n+k, where K is determined by the timing parameter K1.

In embodiments of the disclosure, unicast may refer to a manner in which a network communicates with a UE, and multicast may refer to a manner in which a network communicates with multiple UEs. For example, a unicast PDSCH may be a PDSCH received by a UE, and the scrambling of the PDSCH may be based on a Radio Network Temporary Identifier (RNTI) specific to the UE, e.g., Cell-RNTI (C-RNTI). A multicast PDSCH may be a PDSCH received by more than one UE simultaneously, and the scrambling of the multicast PDSCH may be based on a UE-group common RNTI. For example, the UE-group common RNTI for scrambling the multicast PDSCH may include an RNTI (referred to as G-RNTI in embodiments of the disclosure) for scrambling of a dynamically scheduled multicast transmission (e.g., PDSCH) or an RNTI (referred to as G-CS-RNTI in embodiments of the disclosure) for scrambling of a multicast SPS transmission (e.g., SPS PDSCH). The G-CS-RNTI and the G-RNTI may be different RNTIs or same RNTI. UCI(s) of the unicast PDSCH may include HARQ-ACK information, SR, or CSI of the unicast PDSCH. UCI(s) of the multicast PDSCH may include HARQ-ACK information for the multicast PDSCH. In embodiments of the disclosure, “multicast” may also be replaced by “broadcast”.

In some implementations, a HARQ-ACK codebook may include HARQ-ACK information for one or more PDSCHs and/or DCI. If the HARQ-ACK information for the one or more PDSCHs and/or DCI is transmitted in a same uplink time unit, the UE may generate the HARQ-ACK codebook based on a predefined rule. For example, if a PDSCH is successfully decoded, the HARQ-ACK information for this PDSCH is positive ACK. The positive ACK may be represented by 1 in the HARQ-ACK codebook, for example. If a PDSCH is not successfully decoded, the HARQ-ACK information for this PDSCH is Negative ACK (NACK). NACK may be represented by 0 in the HARQ-ACK codebook, for example. For example, the UE may generate the HARQ-ACK codebook based on the pseudo code specified by protocols. In an example, if the UE receives a DCI format that indicates SPS PDSCH release (deactivation), the UE transmits HARQ-ACK information (ACK) for the DCI format. In another example, if the UE receives a DCI format that indicates secondary cell dormancy, the UE transmits the HARQ-ACK information (ACK) for the DCI format. In yet another example, if the UE receives a DCI format that indicates to transmit HARQ-ACK information (e.g., a Type-3 HARQ-ACK codebook in 3GPP) of all HARQ-ACK processes of all configured serving cells, the UE transmits the HARQ-ACK information of all HARQ-ACK processes of all configured serving cells. In order to reduce a size of the Type-3 HARQ-ACK codebook, in an enhanced Type-3 HARQ-ACK codebook, the UE may transmit HARQ-ACK information of a specific HARQ-ACK process of a specific serving cell based on an indication of the DCI. In yet another example, if the UE receives a DCI format that schedules a PDSCH, the UE transmits HARQ-ACK information for the PDSCH. In yet another example, the UE receives a SPS PDSCH, and the UE transmits HARQ-ACK information for the SPS PDSCH reception. In yet another example, if the UE is configured by higher layer signaling to receive a SPS PDSCH, the UE transmits HARQ-ACK information for the SPS PDSCH reception. The reception of the SPS PDSCH configured by higher layer signaling may be cancelled by other signaling. In yet another example, if at least one uplink symbol (e.g., OFDM symbol) of the UE in a semi-static frame structure configured by higher layer signaling overlaps with a symbol of a SPS PDSCH reception, the UE does not receive the SPS PDSCH. In yet another example, if the UE is configured by higher layer signaling to receive a SPS PDSCH according to a predefined rule, the UE transmits HARQ-ACK information for the SPS PDSCH reception. It should be noted that in embodiments of the disclosure, “‘A’ overlaps with ‘B’” may mean that ‘A’ at least partially overlaps with ‘B’. That is, “‘A’ overlaps with ‘B’” includes a case where ‘A’ completely overlaps with ‘B’.

In some implementations, if HARQ-ACK information transmitted in a same uplink time unit does not include HARQ-ACK information for any DCI format, nor does it include HARQ-ACK information for a dynamically scheduled PDSCH (e.g., a PDSCH scheduled by a DCI format) and/or DCI, or the HARQ-ACK information transmitted in the same uplink time unit only includes HARQ-ACK information for one or more SPS PDSCH receptions, the UE may generate HARQ-ACK information according to a rule for generating a HARQ-ACK codebook for a SPS PDSCH.

In some implementations, if HARQ-ACK information transmitted in a same uplink time unit includes HARQ-ACK information for a DCI format, and/or a dynamically scheduled PDSCH (e.g., a PDSCH scheduled by a DCI format), the UE may generate HARQ-ACK information according to a rule for generating a HARQ-ACK codebook for a dynamically scheduled PDSCH and/or a DCI format. For example, the UE may determine to generate a semi-static HARQ-ACK codebook (e.g., Type-1 HARQ-ACK codebook in 3GPP) or a dynamic HARQ-ACK codebook (e.g., Type-2 HARQ-ACK codebook in 3GPP) according to a PDSCH HARQ-ACK codebook configuration parameter (e.g., the parameter pdsch-HARQ-ACK-Codebook in 3GPP). The dynamic HARQ-ACK codebook may also be an enhanced dynamic HARQ-ACK codebook (e.g., Type-2 HARQ-ACK codebook based on grouping and HARQ-ACK re-transmission in 3GPP).

In some implementations, if HARQ-ACK information transmitted in a same uplink time unit includes only HARQ-ACK information for a SPS PDSCH (e.g., a PDSCH not scheduled by a DCI format), the UE may generate the HARQ-ACK codebook according to a rule for generating a HARQ-ACK codebook for a SPS PDSCH reception (e.g., the pseudo code for generating a HARQ-ACK codebook for a SPS PDSCH reception defined in 3GPP).

The semi-static HARQ-ACK codebook (e.g., 3GPP TS 38.213 Type-1 HARQ-ACK codebook) may determine the size of the HARQ-ACK codebook and an order of HARQ-ACK bits according to a semi-statically parameter (e.g., a parameter configured by higher layer signaling). For a serving cell c, an active downlink BWP (bandwidth part) and an active uplink BWP, the UE determines a set of M_{A,c} occasions for candidate PDSCH receptions for which the UE can transmit corresponding HARQ-ACK information in a PUCCH in an uplink slot n_{U}.

M_{A,c} may be determined by at least one of:
a) HARQ-ACK slot timing values K1 of the active uplink BWP;
b) a downlink time domain resource allocation (TDRA) table;
c) an uplink sub-carrier spacing (SCS) configuration and a downlink SCS configuration;
d) a semi-static uplink and downlink frame structure configuration;
e) a downlink slot offset parameter (e.g., 3GPP parameter N_{slot,offset,c}^{DL}) for the serving cell c and its corresponding SCS parameter (e.g., 3GPP parameter μ_{offset,DL,c}), and a slot offset parameter (e.g., 3GPP parameter N_{slot,offset}^{UL}) for a primary serving cell and its corresponding SCS parameter (e.g., 3GPP parameter μ_{offset,UL}).

The parameter K1 is used to determine a candidate uplink slot, and then determine candidate downlink slots according to the candidate uplink slot. The candidate downlink slots satisfy at least one of the following conditions: (i) if the time unit of the PUCCH is a subslot, the end of at least one candidate PDSCH reception in the candidate downlink slots overlaps with the candidate uplink slot in time domain; or (ii) if the time unit of the PUCCH is a slot, the end of the candidate downlink slots overlap with the candidate uplink slot in time domain. It should be noted that, in embodiments of the disclosure, a starting symbol may be used interchangeably with a starting position, and an end symbol may be used interchangeably with an end position. In some implementations, the starting symbol may be replaced by the end symbol, and/or the end symbol may be replaced by the starting symbol.

A number of PDSCHs in a candidate downlink slot for which HARQ-ACK needs to be fed back may be determined by a maximum value of a number of non-overlapping valid PDSCHs in the downlink slot (e.g., the valid PDSCHs may be PDSCHs that do not overlap with semi-statically configured uplink symbols). Time domain resources occupied by the PDSCHs may be determined by (i) a time domain resource allocation table configured by higher layer signaling (in embodiments of the disclosure, it may also be referred to as a table associated with time domain resource allocation) and (ii) a certain row in the time domain resource allocation table dynamically indicated by DCI. Each row in the time domain resource allocation table may define information with respect to time domain resource allocation. For example, for the time domain resource allocation table, an indexed row defines a timing value (e.g., time unit (e.g., slot) offset (e.g., K0)) between a PDCCH and a PDSCH, and a start and length indicator (SLIV), or directly defines a starting symbol and allocation length. For example, for the first row of the time domain resource allocation table, a start OFDM symbol is 0 and an OFDM symbol length is 4; for the second row of the time domain resource allocation table, the start OFDM symbol is 4 and the OFDM symbol length is 4; and for the third row of the time domain resource allocation table, the start OFDM symbol is 7 and the OFDM symbol length is 4. The DCI for scheduling the PDSCH may indicate any row in the time domain resource allocation table. When all OFDM symbols in the downlink slot are downlink symbols, the maximum value of the number of non-overlapping valid PDSCHs in the downlink slot is 2. At this time, the Type-1 HARQ-ACK codebook may need to feed back HARQ-ACK information for two PDSCHs in the downlink slot on the serving cell.

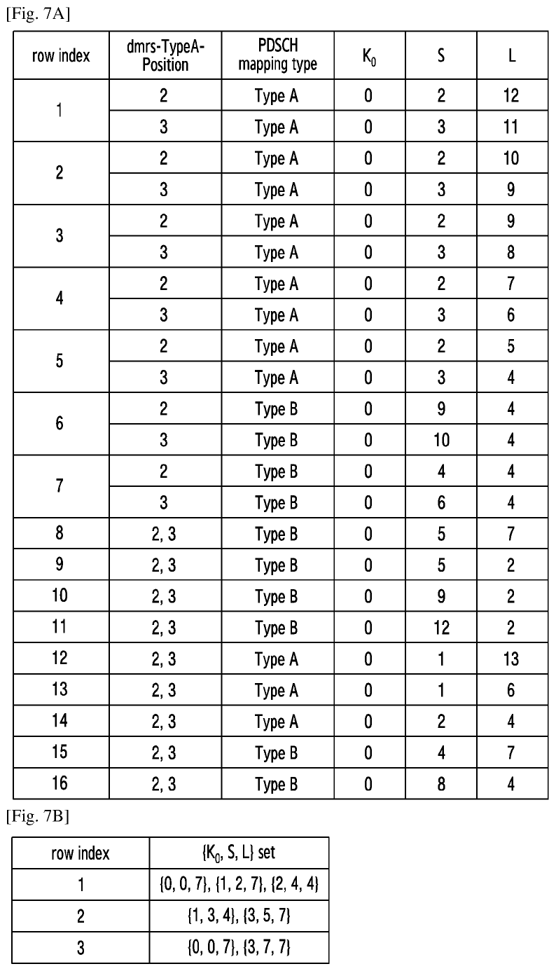

FIGS. 7A and 7B illustrate examples of a time domain resource allocation table. Specifically, FIG. 7A illustrates a time domain resource allocation table in which one PDSCH is scheduled by one row, and FIG. 7B illustrates a time domain resource allocation table in which multiple PDSCHs are scheduled by one row. Referring to FIG. 7A, each row corresponds to a value of a timing parameter K0, a value of S indicating a starting symbol, and a value of L indicating a length, where an SLIV may be determined by the value of S and the value of L. Referring to FIG. 7B, unlike FIG. 7A, each row corresponds to values of multiple sets of {K0, S, L}.

In some implementations, the dynamic HARQ-ACK codebook and/or the enhanced dynamic HARQ-ACK codebook may determine a size and an order of the HARQ-ACK codebook according to an assignment indicator. For example, the assignment indicator may be a DAI (Downlink Assignment Indicator). In the following embodiments, the assignment indicator as the DAI is taken as an example for illustration. However, the embodiments of the disclosure are not limited thereto, and any other suitable assignment indicator may be adopted.

In some implementations, a DAI field includes at least one of a first DAI and a second DAI.

In some examples, the first DAI may be a C-DAI (Counter-DAI). The first DAI may indicate an accumulative number of at least one of DCI scheduling PDSCH(s), DCI indicating SPS PDSCH release (deactivation), or DCI indicating secondary cell dormancy. For example, the accumulative number may be an accumulative number up to the current serving cell and/or the current time unit. For example, C-DAI may refer to: an accumulative number of {serving cell, time unit} pair(s) scheduled by PDCCH(s) up to the current time unit within a time window (which may also include a number of PDCCHs (e.g., PDCCHs indicating SPS release and/or PDCCHs indicating secondary cell dormancy)); or an accumulative number of PDCCH(s) up to the current time unit; or an accumulative number of PDSCH transmission(s) up to the current time unit; or an accumulative number of {serving cell, time unit} pair(s) in which PDSCH transmission(s) related to PDCCH(s) (e.g., scheduled by the PDCCH(s)) and/or PDCCH(s) (e.g., PDCCH indicating SPS release and/or PDCCH indicating secondary cell dormancy) is present, up to the current serving cell and/or the current time unit; or an accumulative number of PDSCH(s) with corresponding PDCCH(s) and/or PDCCHs (e.g., PDCCHs indicating SPS release and/or PDCCHs indicating secondary cell dormancy) already scheduled by a base station up to the current serving cell and/or the current time unit; or an accumulative number of PDSCHs (the PDSCHs are PDSCHs with corresponding PDCCHs) already scheduled by the base station up to the current serving cell and/or the current time unit; or an accumulative number of time units with PDSCH transmissions (the PDSCHs are PDSCHs with corresponding PDCCHs) already scheduled by the base station up to the current serving cell and/or the current time unit. The order of each bit in the HARQ-ACK codebook corresponding to at least one of PDSCH reception(s), DCI(s) indicating SPS PDSCH release (deactivation), or DCI(s) indicating secondary cell dormancy may be determined by the time when the first DAI is received and the information of the first DAI. The first DAI may be included in a downlink DCI format.

In some examples, the second DAI may be a T-DAI (Total-DAI). The second DAI may indicate a total number of at least one of all PDSCH receptions, DCI indicating SPS PDSCH release (deactivation), or DCI indicating secondary cell dormancy. For example, the total number may be a total number of all serving cells up to the current time unit. For example, T-DAI may refer to: a total number of {serving cell, time unit} pairs scheduled by PDCCH(s) up to the current time unit within a time window (which may also include a number of PDCCHs for indicating SPS release); or a total number of PDSCH transmissions up to the current time unit; or a total number of {serving cell, time unit} pairs in which PDSCH transmission(s) related to PDCCH(s) (e.g., scheduled by the PDCCH) and/or PDCCH(s) (e.g., a PDCCH indicating SPS release and/or a PDCCH indicating secondary cell dormancy) is present, up to the current serving cell and/or the current time unit; or a total number of PDSCHs with corresponding PDCCHs and/or PDCCHs (e.g., PDCCHs indicating SPS release and/or PDCCHs indicating secondary cell dormancy) already scheduled by a base station up to the current serving cell and/or the current time unit; or a total number of PDSCHs (the PDSCHs are PDSCHs with corresponding PDCCHs) already scheduled by the base station up to the current serving cell and/or the current time unit; or a total number of time units with PDSCH transmissions (e.g., the PDSCHs are PDSCHs with corresponding PDCCHs) already scheduled by the base station up to the current serving cell and/or the current time unit. The second DAI may be included in the downlink DCI format and/or an uplink DCI format. The second DAI included in the uplink DCI format is also referred to as UL DAI.

In the following examples, the first DAI as the C-DAI and the second DAI as the T-DAI are taken as an example for illustration, but the examples are not limited thereto.

Tables 1 and 2 show a correspondence between the DAI field and V_{T-DAI,m} or V_{C-DAI,c,m}. Numbers of bits of the C-DAI and T-DAI are limited.

For example, in a case where the C-DAI or T-DAI is represented with 2 bits, the value of the C-DAI or T-DAI in the DCI may be determined by equations in Table 1. V_{T-DAI,m} is the value of the T-DAI in DCI received in a PDCCH Monitoring Occasion (MO) m, and V_{C-DAI,c,m} is the value of the C-DAI in DCI for a serving cell c received in the PDCCH monitoring occasion m. Both V_{T-DAI,m} and V_{C-DAI,c,m} are related to a number of bits of the DAI field in the DCI. MSB is the Most Significant Bit and LSB is the Least Significant Bit.

TABLE 1

| MSB, LSB of | V_{T-DAI, m} or | |
|---|---|---|
| DAI Field | V_{C-DAI, c, m} | Y |
| 0, 0 | 1 | (Y − 1) mod 4 + 1 = 1 |
| 0, 1 | 2 | (Y − 1) mod 4 + 1 = 2 |
| 1, 0 | 3 | (Y − 1) mod 4 + 1 = 3 |
| 1, 1 | 4 | (Y − 1) mod 4 + 1 = 4 |

For example, when the C-DAI or T-DAI is 1, 5 or 9, as shown in Table 1, all of the DAI field are indicated with “00”, and the value of V_{T-DAI,m} or V_{C-DAI,c,m} is represented as “1” by the equation in Table 1. Y may represent the value of the DAI corresponding to the number of DCIs actually transmitted by the base station (the value of the DAI before conversion by the equation in the table).

For example, in a case where the C-DAI or T-DAI in the DCI is 1 bit, values greater than 2 may be represented by equations in Table 2.

TABLE 2

| | V_{T-DAI, m} or | |
|---|---|---|
| DAI field | V_{C-DAI, c, m} | Y |
| 0 | 1 | (Y − 1) mod 2 + 1 = 1 |
| 1 | 2 | (Y − 1) mod 2 + 1 = 2 |

It should be noted that, unless the context clearly indicates otherwise, all or one or more of the methods, steps and operations described in embodiments of the disclosure may be specified by protocols and/or configured by higher layer signaling and/or indicated by dynamic signaling. The dynamic signaling may be PDCCH and/or DCI and/or DCI format. For example, SPS PDSCH and/or CG PUSCH may be dynamically indicated in corresponding activated DCI/DCI format/PDCCH. All or one or more of the described methods, steps and operations may be optional. For example, if a certain parameter (e.g., parameter X) is configured, the UE performs a certain approach (e.g., approach A), otherwise (if the parameter, e.g., parameter X, is not configured), the UE performs another approach (e.g., approach B).

It should be noted that, a PCell (Primary Cell) or PSCell (Primary Secondary Cell) in embodiments of the disclosure may be used interchangeably with a cell having a PUCCH.

It should be noted that, methods for downlink in embodiments of the disclosure may also be applicable to uplink, and methods for uplink may also be applicable to downlink. For example, a PDSCH may be replaced with a PUSCH, a SPS PDSCH may be replaced with a CG PUSCH, and downlink symbols may be replaced with uplink symbols, so that methods for downlink may be applicable to uplink.

It should be noted that, methods applicable to scheduling of multiple PDSCH/PUSCHs in embodiments of the disclosure may also be applicable to a PDSCH/PUSCH transmission with repetitions. For example, a PDSCH/PUSCH of multiple PDSCHs/PUSCHs may be replaced by a repetition of multiple repetitions of the PDSCH/PUSCH transmission.

It should be noted that, in methods of the disclosure, a PDCCH and/or a DCI and/or a DCI format schedules multiple PDSCHs/PUSCHs, which may be multiple PDSCHs/PUSCHs of a same serving cell and/or multiple PDSCHs/PUSCHs of different serving cells.

It should be noted that, the multiple manners described in the disclosure may be combined in any order. In a combination, a manner may be performed one or more times.

It should be noted that, the multiple steps in the methods of the disclosure may be implemented in any order.

It should be noted that, in methods of the disclosure, “cancelling a transmission” may mean cancelling the transmission of the entire uplink channel and/or cancelling the transmission of a part of the uplink channel.

It should be noted that, in methods of the disclosure, “an order from small to large” (e.g., an ascending order) may be replaced by “an order from large to small” (e.g., a descending order), and/or “an order from large to small” (e.g., a descending order) may be replaced by “an order from small to large” (e.g., an ascending order).

It should be noted that, in methods of the disclosure, a PUCCH/PUSCH with A may be understood as a PUCCH/PUSCH only carrying A, and may also be understood as a PUCCH/PUSCH including at least A.

It should be noted that, in methods of the disclosure, for a noun, methods of the disclosure may be applicable to one and/or multiple such nouns. The article “a” may also be replaced by “multiple” or “more than one”, and “multiple” or “more than one” may also be replaced by “a”.

It should be noted that “slot” may be replaced by “subslot” or “time unit” in embodiments of the disclosure.

It should be noted that, “at least one” may be understood as “one” or “multiple” in embodiments of the disclosure. For the case of “multiple”, it may be any permutation and combination. For example, at least one of “A”, “B” and “C” may be: “A”, “B”, “C”, “AB”, “BA”, “ABC”, “CBA”, “ABCA”, “ABCCB”, etc.

It should be noted that “slot” in embodiments of the disclosure may also be replaced by other time units.

It should be noted that, in embodiments of the disclosure, “a predefined method (or step) is performed if a predefined condition is satisfied” and “a predefined method (or step) is not performed if a predefined condition is not satisfied” may be used interchangeably. “A predefined method (or step) is not performed if a predefined condition is satisfied” and “a predefined method (or step) is performed if a predefined condition is not satisfied” may be used interchangeably.

It should be noted that, in embodiments of the disclosure, parameters, information or configurations may be preconfigured or predefined or configured by a base station. Therefore, in some cases, parameters, information or configurations may be referred to as predefined parameters, predefined information or predefined configurations, respectively. In embodiments of the disclosure, the meaning of preconfiguring certain information or parameters in a UE may be interpreted as default information or parameters embedded in the UE when the UE is manufactured, or information or parameters acquired in advance through higher layer signaling (e.g., RRC) and stored in the UE, or information or parameters acquired from a base station and stored.

It should be noted that, “resolving overlapping channels”, or “resolving overlapping among channels”, or “resolving overlapping for channels” in embodiments of the disclosure may be understood as resolving collision among overlapping channels and/or resolving collision among a set of overlapping channels. For example, when a PUCCH overlaps with a PUSCH, resolving the overlapping or collision may include multiplexing UCI carried by the PUCCH in the PUSCH, or may include transmitting the PUCCH or PUSCH with higher priority. For another example, when a PUCCH overlaps with a PUCCH or another PUCCH, resolving the overlapping or collision may include multiplexing UCI in a PUCCH, or may include transmitting a PUCCH with higher priority. For another example, when two PUSCHs on a same serving cell overlap, resolving the overlapping or collision may include transmitting a PUSCH with higher priority of the two PUSCHs.

It should be noted that, in embodiments of the disclosure, “a set of overlapping channels” may be understood as each channel of the set of overlapping channels overlapping with at least one of channels in the set other than the channel. The channel may include one or more PUCCHs and/or one or more PUSCHs. For example, “a set of overlapping channels” may include “a set of overlapping PUCCHs and/or PUSCHs”. As a specific example, when a first PUCCH overlaps with at least one of a second PUCCH and a third PUCCH, the second PUCCH overlaps with at least one of the first PUCCH and the third PUCCH, and the third PUCCH overlaps with at least one of the first PUCCH and the second PUCCH, the first PUCCH, the second PUCCH and the third PUCCH constitute a set of overlapping channels (PUCCHs). For example, the first PUCCH overlaps with both the second PUCCH and the third PUCCH, and the second PUCCH does not overlap with the third PUCCH.

It should be noted that collision among a PUSCH and other uplink physical channels and/or downlink physical channels may be at least one of the following:
The PUSCH overlaps with other PUSCHs and/or PUCCHs and/or PDSCHs and/or PDCCHs on a same serving cell in time domain.
The PUSCH overlaps with a PUCCH in time domain. For example, the PUSCH overlaps with a PUCCH on a different serving cell in time domain, and/or the serving cell does not support the simultaneous transmission of the PUSCH and the PUCCH.
A first PUCCH overlaps with a second PUCCH in time domain.
The PUCCH overlaps with a PDSCH on a same serving cell in time domain.

It should be noted that collision among a PDSCH and other uplink physical channels and/or downlink physical channels may be at least one of the following:
The PDSCH overlaps with other PUSCHs and/or PUCCHs and/or PDSCHs and/or PDCCHs on a same serving cell in time domain.
The PDSCH overlaps with a PUCCH in time domain.

In some cases, UE does not expect to be scheduled with more than N (e.g., N is an integer greater than 0, such as N=1) PUSCHs in a time unit (e.g., slot). For example, for a single TRP, for 480/960 kHz SCS, the UE does not expect to be scheduled with more than N (e.g., N is an integer greater than 0, such as N=1) PUSCHs in a time unit (e.g., slot). PUSCHs to be transmitted may be determined by at least one of the following manners MN1˜MN7. As an example, for a single TRP, for 480/960 KHz SCS, PUSCHs to be transmitted may be determined by at least one of the following manners MN1˜MN7. As another example, if the UE reports a capability to indicate that at most N PUSCHs are scheduled in a slot on a serving cell, PUSCHs to be transmitted may be determined by at least one of the following manners (or, examples).

### Manner MN1 (Example 1)

In manner MN1, the UE does not expect to be configured with more than N CG PUSCHs in a time unit on a serving cell. Or, the UE does not expect to be configured with more than N activated CG PUSCHs in a time unit on a serving cell.

In some examples, for a single TRP, for 480/960 kHz SCS, the UE does not expect to be configured with more than N CG PUSCHs in a time unit on a serving cell.

The method is simple to implement and can reduce the implementation complexity of the UE and the base station.

### Manner MN2 (Example 2)

In manner MN2, if more than N activated CG PUSCHs are configured in a time unit on a serving cell, the UE only transmits at most N CG PUSCHs. For example, if more than N activated CG PUSCHs are configured in a time unit on a serving cell, the UE transmits at most N CG PUSCHs with higher priority. For another example, if at least one activated CG PUSCH with the higher priority is configured in a time unit on a serving cell, the UE transmits one CG PUSCH with the higher priority.

In some examples, for a single TRP, for 480/960 kHz SCS, if more than N activated CG PUSCHs are configured in a time unit on a serving cell, the UE only transmits at most N CG PUSCHs.

The method is simple to implement and can reduce the implementation complexity of the UE and the base station.

### Manner MN3 (Example 3)

In manner MN3, PUSCHs to be transmitted may be determined according to one or more of the following steps.

Step 1: determine to transmit at most N CG PUSCHs. For example, it is assumed that there is no DG PUSCH, and at most N CG PUSCHs are determined to be transmitted. For another example, at most N CG PUSCHs are determined to be transmitted based on the method according to other embodiments of the disclosure.

Step 2: determine to transmit at most N DG PUSCHs and/or CG PUSCHs.

In some examples, for a single TRP, for 480/960 kHz SCS, PUSCHs to be transmitted may be determined according to one or more of the above steps.

The method can improve the flexibility of the dynamic scheduling.

### Manner MN4 (Example 4)

In manner MN4, it may be specified by protocols and/or configured by higher layer signaling that, the UE does not expect that a PUSCH scheduled by a DCI/PDCCH does not overlap with a CG PUSCH in time domain in a time unit (e.g., slot) on a serving cell. Or, in a time unit (e.g., slot) on a serving cell, for the same TRP (e.g., 3GPP parameter CORESETPoolIndex is the same), the UE does not expect that a PUSCH scheduled by a DCI/PDCCH does not overlap with a CG PUSCH in time domain.

In some examples, for a single TRP, for 480/960 kHz SCS, it may be specified by protocols and/or configured by higher layer signaling that, the UE does not expect that a PUSCH scheduled by a DCI/PDCCH does not overlap with a CG PUSCH in time domain in a time unit (e.g., slot) on a serving cell.

The method is simple to implement and can reduce the implementation complexity of the UE and the base station.

### Manner MN5 (Example 5)

In manner MN5, in a time unit (e.g., slot) on a serving cell, if a PUSCH scheduled by a DCI/PDCCH and a predefined CG PUSCH and/or all of CG PUSCHs satisfy a first predefined timing condition, the UE transmits the PUSCH scheduled by the DCI/PDCCH, and/or the UE does not transmit or cancels the transmission of the predefined CG PUSCH and/or all of the CG PUSCHs. Or, in a time unit (e.g., slot) on a serving cell, for the same TRP (e.g., 3GPP parameter CORESETPoolIndex is the same), if a PUSCH scheduled by a DCI/PDCCH and a predefined CG PUSCH and/or all of CG PUSCHs satisfy the first predefined timing condition, the UE transmits the PUSCH scheduled by the DCI/PDCCH, and/or the UE does not transmit or cancels the transmission of the predefined CG PUSCH and/or all of the CG PUSCHs. For example, the PUSCH scheduled by the DCI may not overlap with the CG PUSCHs in time domain.

As an example, the predefined CG PUSCH may be a CG PUSCH with the earliest starting time/symbol. As another example, the predefined CG PUSCH may also be a CG PUSCH with the smallest (or largest) CG PUSCH configuration index.

For example, the first predefined timing condition may be that a time interval between an end (or starting) position (or symbol) of the PDCCH (or a CORESET where the DCI is located) and a starting position (or symbol) of the CG PUSCH is greater than a predefined time.

In some examples, for a single TRP, for 480/960 KHz SCS, in a time unit (e.g., slot) on a serving cell, if a PUSCH scheduled by a DCI/PDCCH and a predefined CG PUSCH and/or all of CG PUSCHs satisfy the first predefined timing condition, the UE transmits the PUSCH scheduled by the DCI/PDCCH, and/or the UE does not transmit or cancels the transmission of the predefined CG PUSCH and/or all of the CG PUSCHs.

The method can improve the flexibility of the dynamic scheduling.

### Manner MN6 (Example 6)

In manner MN6, in a time unit (e.g., slot) on a serving cell, if a first PUSCH and a second PUSCH satisfy a predefined condition, the UE transmits the first PUSCH, and/or the UE does not transmit or cancels the transmission of the second PUSCH. Or, in the time unit (e.g., slot) on the serving cell, for the same TRP (e.g., 3GPP parameter CORESETPoolIndex is the same), if the first PUSCH and the second PUSCH satisfy a second predefined timing condition, the UE transmits the first PUSCH, and/or the UE does not transmit or cancels the transmission of the second PUSCH. As an example, the first PUSCH may not overlap with the second PUSCH in time domain. As another example, the first PUSCH overlaps with the second PUSCH in time domain.

For example, the predefined condition may be at least one of the following:
the priority of the first PUSCH is higher than that of the second PUSCH;
the priority of the first PUSCH is the same as that of the second PUSCH, in which the first PUSCH is a DG PUSCH, and the second PUSCH is a CG PUSCH;
the PDCCH scheduling the first PUSCH and the second PUSCH satisfying the second predefined timing condition.

In some examples, the second predefined timing condition may be that a time interval between the end (or starting) position (or symbol) of the PDCCH (or a CORESET where the DCI is located) and the starting position (or symbol) of the second PUSCH is larger than a predefined time. It should be noted that, since a number of PUSCHs transmitted in a time unit (e.g., slot) on a serving cell is limited, the UE may not transmit the second PUSCH or may cancel the transmission (e.g., partially cancel the transmission) of the second PUSCH based on different UE capabilities. For example, when the UE reports UE capability 1 to indicate that a number of the PUSCHs transmitted in a time unit (e.g., slot) on a serving cell is N (e.g., N equals 1), when two PUSCHs on a serving cell overlap in time domain, the UE transmits one PUSCH (e.g., a PUSCH with higher priority), and the UE does not transmit the other PUSCH (e.g., a PUSCH with lower priority). For another example, when the UE reports UE capability 2 to indicate that the number of the PUSCHs transmitted in a time unit (e.g., slot) on a serving cell is N (e.g., N equals 1), when two PUSCHs on a serving cell overlap in time domain, the UE transmits one PUSCH (e.g., a PUSCH with higher priority), and the UE may cancel the transmission of the other PUSCH (e.g., a PUSCH with lower priority).

In some examples, for a single TRP, for a SCS of 480 kHz or 960 kHz, in a slot on a serving cell, when the first PUSCH overlaps with the second PUSCH in time domain, if a predefined condition (e.g., the predefined condition in manner MN6) is satisfied, the UE transmits the first PUSCH, and/or the UE does not transmit the second PUSCH.

The method can improve the flexibility of the dynamic scheduling.

### Manner MN7 (Example 7)

In manner MN7, it may be specified by protocols and/or configured by higher layer signaling that, in a time unit on a serving cell, a number of PUSCHs that the UE is expected to transmit (or to be able to transmit) is not more than N (e.g., N is an integer greater than zero, such as N=1), and/or the UE is not expected to transmit (e.g., be scheduled to transmit/be able to transmit) a number of PUSCHs being more than N.

For example, the PUSCHs that the UE is expected to transmit (or to be able to transmit) may be determined by at least one of the following:
a PUSCH that does not overlap with symbols configured as downlink symbols and/or flexible symbols by higher layer signaling (e.g., 3GPP parameter tdd-UL-DL-ConfigurationCommon and/or tdd-UL-DL-ConfigurationDedicated);
a PUSCH (e.g., CG PUSCH) that does not overlap with symbols indicated as downlink symbols and/or flexible symbols by dynamic signaling (e.g., a dynamic SFI (slot format indicator), information of which is carried by DCI format 2_0);
a PUSCH (e.g., CG PUSCH) that does not overlap with dynamically scheduled PDSCH(s) (e.g., a valid PDSCH, such as a PDSCH that does not overlap with symbols configured as uplink symbols by higher layer signaling) on the same serving cell in time domain;
a PUSCH that does not overlap with PUSCH(s) and/or PUCCH(s) with higher priority on the same serving cell in time domain;
a PUSCH that does not overlap with symbols indicated by an uplink cancellation indication (CI) (e.g., CI carried by DCI format 2_4), for example, the CI may be used to inform the UE to cancel physical resource block(s) (PRB(s)) and symbol(s) of the corresponding UL transmission;
a PUSCH that does not overlap with PUCCH(s) with higher priority in time domain.

For example, when a PUSCH satisfies at least one of the following conditions, the PUSCH may be determined to be the PUSCH that the UE is expected to transmit (or would transmit).

Condition COND1: the PUSCH does not overlap with symbols configured as downlink symbols and/or flexible symbols by higher layer signaling (e.g., 3GPP parameter tdd-UL-DL-ConfigurationCommon and/or tdd-UL-DL-ConfigurationDedicated). For example, when condition CONDI is satisfied, collision among the PUSCH and the symbols indicated as downlink symbols and/or flexible symbols by higher layer signaling can be resolved.

Condition COND2: the PUSCH does not overlap with symbols indicated as downlink symbols and/or flexible symbols by dynamic signaling (e.g., a dynamic SFI, which is carried by DCI format 2_0). For example, when condition COND2 is satisfied, collision among the PUSCH and the symbols indicated as downlink symbols and/or flexible symbols by dynamic signaling may be resolved.

Condition COND3: the PUSCH does not overlap with dynamically scheduled PDSCH(s) on the same serving cell (e.g., a valid PDSCH, such as a PDSCH that does not overlap with symbols configured as uplink symbols by higher layer signaling) in time domain. For example, when condition COND3 is satisfied, collision among the PUSCH and the PDSCH(s) may be resolved.

Condition COND4: the PUSCH does not overlap PUSCH(s) and/or PUCCH(s) with higher priority on the same serving cell in time domain. For example, when condition COND4 is satisfied, collision among the PUSCH and other PUSCH and/or PUCCH with higher priority may be resolved.

Condition COND5: the PUSCH does not overlap with symbols indicated by an uplink CI (e.g., CI carried by DCI format 2_4). For example, when condition COND5 is satisfied, collision among the PUSCH and the symbols indicated by the uplink CI may be resolved.

For example, after the UE resolves the collision with the symbols indicated as downlink symbols and/or flexible symbols by higher layer signaling and/or dynamic signaling, and/or other PUSCH and/or PUCCH and/or PDSCH, in a time unit on a serving cell, a number of PUSCHs that the UE is expected to transmit (e.g., be scheduled to transmit/be able to transmit) is not more than N (e.g., N=1), and/or UE is not expected to transmit (e.g., be scheduled to transmit/be able to transmit) a number of PUSCHs more than N.

It should be noted that, manner NM6 may be limited to the same TRP (e.g., 3GPP parameter CORESETPoolIndex is the same).

In some examples, for a single TRP, for 480/960 kHz SCS, it may be specified by protocols and/or configured by higher layer signaling that, in a time unit on a serving cell, a number of PUSCHs that the UE is expected to transmit (or be able to transmit) is not more than N (e.g., N is an integer greater than zero, such as N=1), and/or the UE is not expected to transmit (e.g., be scheduled to transmit/be able to transmit) a number of PUSCHs more than N.

The method can improve the flexibility of the dynamic scheduling and reduce the delay of the uplink user plane.

In some cases, the UE does not expect to be scheduled with more than M (e.g., M is an integer greater than zero, such as M=1) PDSCHs in a time unit (e.g., slot) on a serving cell. For example, for 480/960 kHz SCS, for a scenario of single TRP, the UE does not expect to be scheduled with more than M (e.g., M is an integer greater than zero, such as M=1) PDSCHs in a time unit (e.g., slot) on a serving cell. In these cases, PDSCHs to be received may be determined by at least one of the following manners MN8˜MN10. For example, for a single TRP, for 480/960 kHz SCS, PDSCHs to be received may be determined by at least one of the following manners MN8˜MN10. For another example, if the UE reports a capability to indicate that at most M PDSCHs can be received in a slot on a serving cell, PDSCHs to be received may be determined by at least one of the following manners.

### Manner MN8 (Example 8)

In manner MN8, it may be specified by protocols and/or configured by higher layer signaling that, in a time unit (e.g., slot) on a serving cell, the UE does not expect that a PDSCH scheduled by a DCI/PDCCH does not overlap with a SPS PDSCH in time domain. Or, in a time unit (e.g., slot) on a serving cell, for the same TRP (e.g., 3GPP parameter CORESETPoolIndex is the same), the UE does not expect that a PDSCH scheduled by a DCI/PDCCH does not overlap with a SPS PDSCH in time domain.

In some examples, for a single TRP, for 480/960 kHz SCS, it may be specified by protocols and/or configured by higher layer signaling that, in a time unit (e.g., slot) on a serving cell, the UE does not expect that a PDSCH scheduled by a DCI/PDCCH does not overlap with a SPS PDSCH in time domain.

The method is simple to implement and can reduce the implementation complexity of the UE and the base station.

### Manner MN9 (Example 9)

In manner MN9, in a time unit (e.g., slot) on a serving cell, if a PDSCH scheduled by a DCI/PDCCH and a predefined SPS PDSCH and/or all of SPS PDSCHs satisfy a third predefined timing condition, the UE receives the PDSCH scheduled by the DCI/PDCCH, and/or the UE does not receive or expect to receive the predefined SPS PDSCH and/or all of the SPS PDSCHs. Or, in a time unit (e.g., slot) on a serving cell, for the same TRP (e.g., 3GPP parameter CORESETPoolIndex is the same), if a PDSCH scheduled by a DCI/PDCCH and a predefined SPS PDSCH and/or all of SPS PDSCHs satisfy the third predefined timing condition, the UE receives the PDSCH scheduled by the DCI/PDCCH, and/or the UE does not receive or expect to receive the predefined SPS PDSCH and/or all of the SPS PDSCHs. For example, the PDSCH scheduled by DCI may not overlap with the SPS PDSCHs in time domain.

For example, the predefined SPS PDSCH may be a SPS PDSCH with the earliest starting time/symbol. For another example, the predefined SPS PDSCH may also be a SPS PDSCH with the smallest (or largest) SPS PDSCH configuration index.

For example, the third predefined timing condition may be that a time interval between an end (or starting) position (or symbol) of the PDCCH (or a CORESET where the DCI is located) and a starting position (or symbol) of the SPS PDSCH is larger than a predefined time.

In some examples, for a single TRP, for 480/960 kHz SCS, in a time unit (e.g., slot) on a serving cell, if a PDSCH scheduled by a DCI/PDCCH and a predefined SPS PDSCH and/or all of SPS PDSCHs satisfy the third predefined timing condition, the UE receives the PDSCH scheduled by the DCI/PDCCH, and/or the UE does not receive or expect to receive the predefined SPS PDSCH and/or all of the SPS PDSCHs.

The method can improve the flexibility of the dynamic scheduling.

### Manner MN10 (Example 10)

In manner MN10, it may be specified by protocols and/or configured by higher layer signaling that, in a time unit on a serving cell, a number of PDSCs that the UE expects to receive (or be able to receive) is not more than M (e.g., M=1), and/or the UE does not expect to receive (or be able to receive) a number of PDSCHs more than M. For example, the PDSCHs that the UE expects to receive (or be able to receive) may be determined by at least one of the following:
a PDSCH that does not overlap with symbols configured as uplink symbols and/or flexible symbols by higher layer signaling (e.g., 3GPP parameter tdd-UL-DL-ConfigurationCommon and/or tdd-UL-DL-ConfigurationDedicated);
a PDSCH (e.g., SPS PDSCH) that does not overlap with symbols indicated as uplink symbols and/or flexible symbols by dynamic signaling (e.g., slot format indicator (SFI), which is carried by DCI format 2_0);
a PDSCH (e.g., SPS PDSCH) that does not overlap with dynamically scheduled PUSCH(s) on the same serving cell (e.g., a valid PUSCH, such as a PUSCH that does not overlap with symbols configured as uplink symbols by higher layer signaling) in time domain;
a PDSCH that does not overlap with PDSCH(s) with higher priority on the same serving cell in time domain;
a PDSCH (e.g., SPS PDSCH) that does not overlap with dynamically scheduled PUCCH(s) in time domain.

For example, when a PDSCH satisfies at least one of the following conditions, the PDSCH may be determined to be the PDSCH that the UE expects to receive (or be able to receive).

Condition COND6: the PDSCH does not overlap with symbols configured as uplink symbols and/or flexible symbols by higher layer signaling (e.g., 3GPP parameter tdd-UL-DL-ConfigurationCommon and/or tdd-UL-DL-ConfigurationDedicated). For example, when condition COND6 is satisfied, collision among the PDSCH and the symbols indicated as uplink symbols and/or flexible symbols by higher layer signaling may be resolved.

Condition COND7: the PDSCH does not overlap with symbols indicated as uplink symbols and/or flexible symbols by dynamic signaling (e.g., SFI). When condition COND7 is satisfied, collision among the PDSCH and the symbols indicated as uplink symbol and/or flexible symbol by dynamic signaling may be resolved.

Condition COND8: the PDSCH does not overlap with dynamically scheduled PUSCH(s) (e.g., a valid PUSCH, such as a PUSCH that does not overlap with symbols configured as uplink symbols by higher layer signaling) on the same serving cell in time domain. For example, when condition COND8 is satisfied, collision among the PDSCH and the PUSCH(s) may be resolved.

Condition COND9: the PDSCH does not overlap with PDSCH(s) with higher priority on the same serving cell in time domain. For example, when condition COND9 is satisfied, collision among the PDSCH and another PDSCH may be resolved.

Condition COND10: the PDSCH does not overlap with dynamically scheduled PUCCH(s) in time domain. For example, when condition COND10 is satisfied, collision among the PDSCH and the PUCCH(s) may be resolved.

For example, after the UE resolves the collision with the symbols indicated as uplink and/or flexible by higher layer signaling and/or dynamic signaling, and/or other PDSCH and/or PUCCH and/or PUSCH, in a time unit on a serving cell, a number of PDSCHs that the UE receives (e.g., is scheduled to receive/expects to receive/may receive) is not more than M (e.g., M=1), and the UE does not expect to receive (or be able to receive) a number of PDSCHs more than M.

It should be noted that, NM9 may be limited to the same TRP (e.g., 3GPP parameter CORESETPoolIndex is the same).

In some examples, for a single TRP, for 480/960 kHz SCS, it may be specified by protocols and/or configured by higher layer signaling that, in a time unit on a serving cell, a number of PDSCHs that the UE expects to receive (or may receive) is not more than M (e.g., M=1), and/or the UE does not expect to receive (or be able to receive) a number of PDSCHs more than M.

The method can improve the flexibility of the dynamic scheduling and reduce the delay of the uplink user plane.

### Manner MN11 (Example 11)

In manner MN11, a MAC entity shall
1>if the buffer status report (BSR) procedure determines that at least one BSR has been triggered and not cancelled:
2>if a regular BSR has been triggered and a logical channel SR delay timer (e.g., the parameter logicalChannelSR-DelayTimer) is not running:
3>if there is no UL-SCH (Uplink Shared Channel) resource available for new transmission and no PUSCH with SP-CSI is activated (or there is no PUSCH resource carrying the SP-CSI) (for example, the PUSCH overlaps with a PUCCH with SR in time domain);
4>trigger a scheduling request (SR)

The method can avoid the overlapping of the PUCCH with SR and the PUSCH with SP-CSI in time domain, and can reduce the implementation complexity of the UE.

In some cases, the UE may transmit and/or receive multiple (for example, two) overlapping channels, and at least one of the following manners MN12˜MN13 may be used to receive and/or transmit channels.

### Manner MN12 (Example 12)

In manner MN12, the UE first resolves overlapping for multiple PUSCHs on a same serving cell, and then resolves overlapping for PUCCH(s) and PUSCH(s). For example, the UE first resolves the overlapping for the multiple PUSCHs on the same serving cell (e.g., the multiple PUSCHs with the same priority), and then resolves the overlapping for the PUCCH(s) and the PUSCH(s) (e.g., a PUCCH and a PUSCH with the same priority).

The overlapping among the multiple PUSCHs on the same serving cell may include at least one of:
a PUSCH with semi-persistent CSI (SP-CSI) (e.g., a PUSCH with SP-CSI without PDCCH scheduling) overlapping with a PUSCH scheduled by DCI/PDCCH.
a CG PUSCH overlapping with a PUSCH scheduled by DCI/PDCCH.
a PUSCH with SP-CSI (semi-persistent CSI) (e.g., a PUSCH with SP-CSI without PDCCH scheduling) overlapping with a CG PUSCH.

In some implementations, if a PUSCH with SP-CSI (e.g., a PUSCH with SP-CSI without PDCCH scheduling) overlaps with both a first PUSCH scheduled by DCI/PDCCH and a second CG PUSCH, the UE does not transmit the PUSCH with SP-CSI (or the UE does not transmit a CSI report; for example, the transmission of the PUSCH with SP-CSI is cancelled by a CG PUSCH), and the DCI/PDCCH scheduling the first PUSCH and the PUSCH with SP-CSI do not need to satisfy a timing condition, the scheduling flexibility and reduce the scheduling delay can be improved in this way.

In some implementations, it may be specified by protocols that the UE is not expected that a PUSCH with SP-CSI (e.g., a PUSCH with SP-CSI without PDCCH scheduling) overlaps with both a first PUSCH scheduled by DCI/PDCCH and a second CG PUSCH. This can reduce the implementation complexity of the UE.

If the transmission of the CG PUSCH and/or the PUSCH with SP-CSI is cancelled by the PUSCH scheduled by DCI/PDCCH, the UE will not multiplex UCI carried by a PUCCH in the CG PUSCH and/or the PUSCH with SP-CSI, the transmission probability of the UCI and improve the reliability of the UCI transmission can be increased in this way.

### Manner MN13 (Example 13)

In manner MN13, the UE first resolves overlapping for multiple PUSCHs and/or PDSCHs on a same serving cell, and then resolves overlapping for PUCCH(s) and PUSCH(s) and/or PDSCH(s).

In some implementations, if a PUSCH with SP-CSI (e.g., a PUSCH with SP-CSI without PDCCH scheduling) overlaps with both a PDSCH scheduled by DCI/PDCCH and a CG PUSCH, the UE does not transmit the PUSCH with SP-CSI (or the UE does not transmit a CSI report; for example, the transmission of the PUSCH with SP-CSI is cancelled by the CG PUSCH). As a result, the DCI/PDCCH scheduling the PDSCH and the PUSCH with SP-CSI do not need to satisfy a timing condition, the scheduling flexibility and reduce the scheduling delay can be improved in this way.

In some implementations, it may be specified by protocols that the UE is not expected that a PUSCH with SP-CSI (e.g., a PUSCH with SP-CSI without PDCCH scheduling) overlaps with both the PDSCH and the CG PUSCH scheduled by DCI/PDCCH. This can reduce the implementation complexity of the UE.

If the transmission of the CG PUSCH and/or the PUSCH with SP-CSI is cancelled by the PDSCH scheduled by DCI/PDCCH, the UE will not multiplex UCI carried by a PUCCH in the CG PUSCH and/or the PUSCH with SP-CSI, the transmission probability of the UCI and improve the reliability of the UCI transmission can be increased in this way.

### Manner MN14 (Example 14)

In manner MN14, the UE first resolves overlapping for PUCCH and/or PUSCH transmission(s) with lower priority, and then, if a PUCCH or PUSCH transmission with lower priority overlaps with a PUCCH or PUSCH transmission with higher priority which is semi-statically configured (e.g., a PUCCH or PUSCH transmission without PDCCH/DCI scheduling), the UE does not transmit the PUCCH or PUSCH transmission with lower priority. At this time, if a PUCCH or PUSCH transmission with higher priority scheduled by PDCCH/DCI overlaps with the PUCCH or PUSCH transmission with lower priority in time domain, the PDCCH reception scheduling the PUCCH or PUSCH transmission with higher priority and the PUCCH or PUSCH transmission with lower priority does not need to satisfy a timing condition.

It should be noted that, in embodiments of the disclosure, a PUCCH or PUSCH without PDCCH/DCI scheduling may be a CG PUSCH and/or a PUSCH with SP-CSI.

Manner MN14 may be used in a scenario where the UE determines overlapping among PUCCHs and/or PUSCHs with different priorities when the UE is not configured with a parameter indicating multiplexing with different priorities (e.g., the parameter uci-Mux WithDiffPrio).

The method can increase the scheduling flexibility and reduce the scheduling delay.

### Manner MN15 (Example 15)

In manner MN15, the UE first resolves overlapping for PUCCH and/or PUSCH transmission(s) with lower priority, then the UE resolves overlapping for PUSCHs on a same serving cell (if any) (for example, does not transmit the PUSCH transmission with lower priority), and then the UE resolves overlapping for PUCCH transmission(s) and PUSCH transmission(s) with different priorities. For example, the UE cancels the PUCCH transmission with lower priority from the first overlapping symbol. At this time, the UE expects that a PUSCH with higher priority is no earlier than a time of T_{proc,2} after being scheduled with a PDCCH reception, where T_{proc,2} is a predefined time.

Manner MN15 may be used in a scenario where the UE determines overlapping among PUCCHs and/or PUSCHs with different priorities when the UE is not configured with a parameter indicating multiplexing with different priorities (e.g., the parameter uci-Mux WithDiffPrio).

The method can increase the scheduling flexibility and reduce the scheduling delay.

Manner MN16 (Example 16)

In manner MN16, if a PUCCH with SR overlaps with a PUSCH with SP-CSI in time domain (for example, the PUCCH has the same priority as the PUSCH), the UE transmits the PUCCH with SR, but does not transmit the PUSCH with SP-CSI. This can increase the probability of the SR transmission and reduce the delay of the uplink transmission. Or, the UE does not transmit the PUCCH with SR, and transmits the PUSCH with SP-CSI. This can increase the probability of the SP-CSI transmission and improve the reliability of the uplink transmission.

In some implementations, it may be specified by protocols that the UE is not expected that a PUCCH with SR overlaps with a PUSCH with SP-CSI in time domain (for example, the PUCCH with SR has the same priority as the PUSCH with SP-CSI), which can reduce the implementation complexity of the UE.

In some implementations, if a PUCCH overlaps with a PUSCH with SP-CSI in time domain (for example, the PUCCH has the same priority as the PUSCH), the UE transmits the PUCCH, and does not transmit the PUSCH with SP-CSI. This can increase the probability of UCI transmission in the PUCCH.

In some implementations, if a PUSCH with SP-CSI overlaps with a PUCCH with SR and a PUCCH with HARQ-ACK and/or CSI in time domain (for example, the PUCCH has the same priority as the PUSCH), the UE does not transmit the PUSCH with SP-CSI, and/or the UE transmits the PUCCH with SR and/or the PUCCH with HARQ-ACK and/or CSI. This can increase the probability of UCI transmission in the PUCCH.

In some implementations, it may be specified by protocols that the UE is not expected that a PUSCH with SP-CSI overlaps with a PUCCH with SR and a PUCCH with HARQ-ACK and/or CSI in time domain (for example, the PUSCH overlaps with the two PUCCHs), which can reduce the implementation complexity of the UE.

It should be noted that, in embodiments of the disclosure, “determine to receive” (or, “determine to be received”) may be replaced by “receive” (or, “received”), and “determine to transmit” (or, “determine to be transmitted”) may be replaced by “transmit” (or, “transmitted”).

It should be noted that, in embodiments of the disclosure, the method applicable to CG PUSCH (or PUSCH without PDCCH/DCI scheduling) is also applicable to PUSCH with SP-CSI (semi-persistent CSI) (e.g., PUSCH with SP-CSI without PDCCH scheduling). For example, CG PUSCH in embodiments of the disclosure may be replaced by PUSCH with SP-CSI (semi-persistent CSI) (e.g., PUSCH with SP-CSI without PDCCH scheduling).

FIG. 8 illustrates a flowchart of a method 800 performed by a terminal (e.g., UE) according to some embodiments of the disclosure.

Referring to FIG. 8, in operation S810, a physical uplink shared channel (PUSCH) from one or more PUSCHs is transmitted and/or a physical downlink shared channel (PDSCH) from one or more PDSCHs is received. The one or more PUSCHs include dynamically scheduled PUSCHs and/or configured grant (CG) PUSCHs, and the one or more PDSCHs include dynamically scheduled PDSCHs and/or semi-persistent scheduling (SPS) PDSCHs.

In some implementations, when a maximum number of PUSCHs that can be transmitted in a time unit on a serving cell is N, where N is a positive integer, the physical uplink shared channel (PUSCH) from the one or more PUSCHs is transmitted.

In some examples, the transmitting of the PUSCH may be based on at least one of the following:
the terminal does not expect to be configured with more than N CG PUSCHs in the time unit on the serving cell;
the terminal transmits at most N CG PUSCHs in case that more than N activated CG PUSCHs are configured in the time unit on the serving cell;
the terminal transmits at most N CG PUSCHs;
the terminal transmits at most N dynamically scheduled PUSCHs and/or CG PUSCHs;
the terminal does not expect that a dynamically scheduled PUSCH does not overlap with the CG PUSCHs in time domain in the time unit on the serving cell;
the terminal transmits a dynamically scheduled PUSCH and/or does not transmit a predefined CG PUSCH and/or all of the CG PUSCHs in the time unit on the serving cell, if the dynamically scheduled PUSCH and the predefined CG PUSCH and/or all of the CG PUSCHs satisfy a predefined timing condition; or
a number of PUSCHs that the terminal is expected to transmit is not more than N, and/or the terminal is not expected to transmit a number of PUSCHs more than N in the time unit on the serving cell.

In some sub-examples, the PUSCHs that the terminal is expected to transmit may be determined based on at least one of the following:
a PUSCH that does not overlap with symbols indicated as downlink and/or flexible by higher layer signaling;
a PUSCH that does not overlap with symbols indicated as downlink and/or flexible by dynamic signaling;
a PUSCH that does not overlap with a dynamically scheduled PDSCH on the same serving cell in time domain;
a PUSCH that does not overlap with PUSCHs and/or PUCCHs with higher priority on the same serving cell in time domain;
a PUSCH that does not overlap with symbols indicated by an uplink cancellation indication; or
a PUSCH that does not overlap with PUCCHs with higher priority in time domain.

In some implementations, the PDSCH from the one or more PDSCHs is received when a maximum value of a number of PDSCHs that can be received in the time unit on the serving cell is M, where M is a positive integer.

In some examples, the receiving of the PDSCH may be based on at least one of the following:
the terminal does not expect that a dynamically scheduled PDSCH does not overlap with the SPS PDSCHs in time domain in the time unit on the serving cell;
in the time unit on the serving cell, the terminal receives a dynamically scheduled PDSCH, and/or does not receive or does not expect to receive a predefined SPS PDSCH and/or all of the SPS PDSCHs, if the dynamically scheduled PDSCH and the predefined SPS PDSCH and/or all of the SPS PDSCHs satisfy a predefined timing condition;
a number of PDSCHs that the terminal expects to receive is not more than M, and/or the terminal does not expect to receive a number of PDSCHs more than M.

In some sub-examples, the PDSCHs that the terminal expects to transmit may be determined based on at least one of the following:
a PDSCH that does not overlap with symbols indicated as uplink and/or flexible by higher layer signaling;
a PDSCH that does not overlap with symbols indicated as uplink and/or flexible by dynamic signaling;
a PDSCH that does not overlap with a dynamically scheduled PUSCH on the same serving cell in time domain;
a PDSCH that does not overlap with a PDSCH with higher priority on the same serving cell in time domain; or
a PDSCH that does not overlap with a dynamically scheduled PUCCH in time domain.

In some implementations, the UE may be scheduled with more than one PDSCH (e.g., more than one PDSCH on a serving cell) by a DCI format, and the UE may be configured with HARQ-ACK bundling in time domain. For a semi-static HARQ-ACK codebook, the UE may determine a position of HARQ-ACK for multiple PDSCHs scheduled by a DCI format in the HARQ-ACK codebook according to the last PDSCH of the multiple PDSCHs.

In some implementations, the UE is configured with a semi-static HARQ-ACK codebook, and the UE is configured to receive multiple PDSCHs scheduled by a DCI on a serving cell (e.g., a row in a TDRA table contains multiple SLIVs). If the UE is configured with PDSCH bundling (e.g., the UE is configured with 3GPP parameter enableTimeDomainHARQ-Bundling), the UE may convert the TDRA table into a TDRA table in which a row contains only one SLIV (a number of SLIVs in a row is 1), and the SLIV of each row in the converted TDRA table corresponds to the last SLIV of the row in the original TDRA table.

For example, set R′ as a set of PDSCH time domain resource allocation (TDRA) tables. Set R as a set of the last SLIV of each row in set R′.

For a serving cell c, if the UE is not configured with a parameter with respect to PDSCH transmission with repetitions (e.g., 3GPP parameter pdsch-AggregationFactor and/or pdsch-AggregationFactor-r16, where pdsch-AggregationFactor is configured in parameter PDSCH-Config, and pdsch-AggregationFactor-r16 is configured in parameter SPS-Config), the UE may determine whether the SLIV corresponding to row r of set R is a valid SLIV according to the corresponding row r in set R′. For example, if at least one symbol in each SLIV corresponding to the corresponding row r in set R′ is configured (e.g., configured by higher layer signaling (e.g., 3GPP parameter tdd-UL-DL-ConfigurationCommon, and/or tdd-UL-DL-ConfigurationDedicated)) as uplink, the corresponding row of set R is deleted (at this time, the row is an invalid SLIV).

For the serving cell c, if the UE is configured with the parameter with respect to PDSCH transmission with repetitions (e.g., 3GPP parameter pdsch-AggregationFactor and/or pdsch-AggregationFactor-r16, where pdsch-AggregationFactor is configured in parameter PDSCH-Config, and pdsch-AggregationFactor-r16 is configured in parameter SPS-Config), the UE may determine whether the SLIV corresponding to row r of set R is a valid SLIV according to the corresponding row r in set R′ and set R. For example, if at least one of each SLIV corresponding to the corresponding row r in set R′ is configured as an uplink symbol by higher layer signaling (e.g., 3GPP parameter tdd-UL-DL-ConfigurationCommon, and/or tdd-UL-DL-ConfigurationDedicated) and for each slot from slot n_{0,k}+n_{D}−N_{PDSCH}^{repeat,max}+1 to slot n_{0,k}+n_{D}, at least one symbol of the time domain resource of the PDSCH corresponding to row r is configured (e.g., configured by higher layer signaling (e.g., 3GPP parameter tdd-UL-DL-ConfigurationCommon, and/or tdd-UL-DL-ConfigurationDedicated)) as uplink, where K_{1,k} is a k-th slot timing value in set K₁, and slot n_{0,k} is a downlink slot with a smallest index among downlink slots overlapping with uplink slot n_{U}−K_{1,k} (or in uplink slot n_{U}−K_{1,k}), and the corresponding row of set R is deleted (at this time, the row is an invalid SLIV).

In an example, for a serving cell c, an active downlink BWP, and an active uplink BWP, the UE determines a set of M_{A,c} occasions for candidate PDSCH receptions for which the UE would transmit corresponding HARQ-ACK information in a PUCCH in uplink slot n_{U}. For a set of slot timing values K₁, the UE may delete a row in a TDRA set corresponding to an invalid SLIV according to at least one of pseudo code-1 of table 3.

TABLE 3
[Pseudo code−1]

```
while r < [symbol] (R)
  if the UE is not configured with the parameter with respect to enabling of
  time domain HARQ bundling (e.g., 3GPP parameter
  enableTimeDomainHARQ-Bundling) and is configured with tdd-UL-DL-
  ConfigurationCommon, or tdd-UL-DL-ConfigurationDedicated and, for
  each slot from slot n_{0,k} + n_{D} − N_{PDSCH}^{repeat,max} + 1 to slot n_{0,k} + n_{D}, at least
  one symbol of the PDSCH time domain resource corresponding to row r is
  configured as uplink where K_{1,k} is the k-th slot timing value in set K₁,
  where slot n_{0,k} is a downlink slot with a smallest index among downlink
  slots overlapping with uplink slot n_{U} − K_{1,k} (or in uplink slot n_{U} − K_{1,k}),
  or, if the subslot length parameter is configured for the HARQ-ACK
  codebook and the end of the PDSCH time domain resource corresponding to
  row r is not within any uplink slot n_{U} − K_{1,l}, where 0 ≤ l < [symbol] (K₁),
  or, HARQ-ACK information for PDSCH corresponding to row r in slot
  n_{0,k} + n_{D} (or slot └(n_{U} − K_{1,k}) · 2^{μ}^{_{DL}}^{-μ}^{_{UL}} + n_{D}) cannot be reported (or
  transmitted, or provided) in slot n_{U} (e.g., the UE is configured with
  scheduling of multiple PDSCHs (e.g., the UE is configured with 3GPP
  parameter PDSCH-TimeDomainResourceAllocationListForMultiPDSCH)
    R = R\r;
  elseif the UE is configured with the parameter with respect to enabling of
  time domain HARQ bundling (e.g., 3GPP parameter
  enableTimeDomainHARQ-Bundling) and the UE is configured with tdd-UL-
  DL-ConfigurationCommon, or tdd-UL-DL-ConfigurationDedicated, and the
  UE is not configured with the parameter with respect to PDSCH
  transmission with repetitions (e.g., 3GPP parameter pdsch-
  AggregationFactor and/or pdsch-AggregationFactor-r16), for each slot in
  slot n_{0,k} + n_{D} − ΔK_{0,r}(d) (or slot └(n_{U} − K_{1,K}) · 2^{μ}^{_{DL}}^{-μ}^{_{UL}}┘ + n_{D} −
  ΔK_{0,r}(d)), at least one symbol of the PDSCH time domain resource
  corresponding to row r of set R′ is configured as uplink, where K_{1,k} is
  the k-th slot timing value in set K₁, slot n_{0,k} is a downlink slot with a
  smallest index among downlink slots overlapping with uplink slot n_{U} −
  K_{1,k} (or in uplink slot n_{U} − K_{1,k}), ΔK_{0,r}(d) is the difference between the
  maximum value of K₀ in row r and K₀ of the element with an index d (e.g.,
  $Δ {K}_{0 , r} = {max}_{{K}_{0}} ( {K}_{0 , r} ) - {K}_{0 , r} ) , where d = 0 , 1 , … , 𝒞 ( Δ {K}_{0 , r} ) - 1 , and 𝒞 ( Δ {K}_{0 , r} )$
  is the cardinality of ΔK_{0,r}(d).
    R = R\r;
    R′ = R′\r;
  elseif the UE is configured with the parameter with respect to enabling of
  time domain HARQ bundling (e.g., 3GPP parameter
  enableTimeDomainHARQ-Bundling) and the UE is configured with tdd-UL-
  DL-ConfigurationCommon, or tdd-UL-DL-ConfigurationDedicated, and the
  UE is configured with the parameter with respect to PDSCH transmission
  with repetitions (e.g., 3GPP parameter pdsch-AggregationFactor and/or
  pdsch-AggregationFactor-r16), for each slot in slot n_{0,k} + n_{D} − ΔK_{0,r}(d)
  (or slot (n_{U} − K_{1,k}) · 2^{μ}^{_{DL}}^{-μ}^{_{UL}} + n_{D} − ΔK_{0,r}(d)), at least one symbol of
  the PDSCH time domain resource corresponding to row r of set R′ is
  configured as uplink, and for each slot from slot n_{0,k} + n_{D} − N_{PDSCH}^{repeat,max} +
  1 to slot n_{0,k} + n_{D}, at least one symbol of the PDSCH time domain
  resource corresponding to row r of set R is configured as uplink, where
  K_{1,k} is the k-th slot timing value in set K₁, slot n_{0,k} is a downlink slot with
  a smallest index among downlink slots overlapping with uplink slot n_{U} −
  K_{1,k} (or in uplink slot n_{U} − K_{1,k}), ΔK_{0,r}(d) is the difference between the
  maximum value of K₀ in row r and K₀ of the element with an index d (e.g.,
  $Δ {K}_{0 , r} = {max}_{{K}_{0}} ( {K}_{0 , r} ) - {K}_{0 , r} ) , where d = 0 , 1 , … , 𝒞 ( Δ {K}_{0 , r} ) - 1 , and 𝒞 ( Δ {K}_{0 , r} )$
  is the cardinality of ΔK_{0,r}(d).
    R = R\r;
    R′ = R′\r;
  else
    r = r + 1;
  end if
end while
```

TABLE 4
[Pseudo code−2]

```
while r < [symbol] (R)
  if the UE is not configured with the parameter with respect to enabling of
  time domain HARQ bundling (e.g., 3GPP parameter
  enableTimeDomainHARQ-Bundling) and is configured with tdd-UL-DL-
  ConfigurationCommon, or tdd-UL-DL-ConfigurationDedicated and, for
  each slot from slot n_{0,k} + n_{D} − N_{PDSCH}^{repeat,max} + 1 to slot n_{0,k} + n_{D}, at least
  one symbol of the PDSCH time domain resource corresponding to row r is
  configured as uplink where K_{1,k} is the k-th slot timing value in set K₁,
  where slot n_{0,k} is a downlink slot with a smallest index among downlink
  slots overlapping with uplink slot n_{U} − K_{1,k} (or in uplink slot n_{U} − K_{1,k}),
  or, if the subslot length parameter is configured for the HARQ-ACK
  codebook and the end of the PDSCH time domain resource corresponding to
  row r is not within any uplink slot n_{U} − K_{1,l}, where 0 ≤ l < [symbol] (K₁),
  or, HARQ-ACK information for PDSCH corresponding to row r in slot
  n_{0,k} + n_{D} (or slot └(n_{U} − K_{1,k}) . 2^{μ}^{_{DL}}^{-μ}^{_{UL}}┘ + n_{D}) cannot be reported (or
  transmitted, or provided) in slot n_{U} (e.g., the UE is configured with
  scheduling of multiple PDSCHs (e.g., the UE is configured with 3GPP
  parameter PDSCH-TimeDomainResourceAllocationListForMultiPDSCH)
    R = R\r;
  elseif the UE is configured with the parameter with respect to enabling of
  time domain HARQ bundling (e.g., 3GPP parameter
  enableTimeDomainHARQ-Bundling) and the UE is configured with tdd-UL-
  DL-ConfigurationCommon, or tdd-UL-DL-ConfigurationDedicated, for
  each slot in slot n_{0,k} + n_{D} − ΔK_{0,r}(d) (or slot └(n_{U} − K_{1,k}) . 2^{μ}^{_{DL}}^{-μ}^{_{UL}}┘ +
  n_{D} − ΔK_{0,r}(d)), at least one symbol of the PDSCH time domain resource
  corresponding to row r of set R′ is configured as uplink, and if the UE is
  configured with the parameter with respect to PDSCH transmission with
  repetitions (e.g., 3GPP parameter pdsch-AggregationFactor and/or pdsch-
  AggregationFactor-r16), for cach slot from slot n_{0,k} + n_{D} − N_{PDSCH}^{repeat,max} +
  1 to slot n_{0,k} + n_{D}, at least one symbol of the PDSCH time domain
  resource corresponding to row r of set R is configured as uplink, where
  K_{1,k} is the k-th slot timing value in set K₁, slot n_{0,k} is a downlink slot with
  a smallest index among downlink slots overlapping with uplink slot n_{U} −
  K_{1,k} (or in uplink slot n_{U} − K_{1,k}), ΔK_{0,r}(d) is the difference between the
  maximum value of K₀ in row r and K₀ of the element with an index d (e.g.,
  $Δ {K}_{0 , r} = {max}_{{K}_{0}} ( {K}_{0 , r} ) - {K}_{0 , r} ) , where d = 0 , 1 , … , 𝒞 ( Δ {K}_{0 , r} ) - 1 , and 𝒞 ( Δ {K}_{0 , r} )$
  is the cardinality of ΔK_{0,r}(d).
    R = R\r;
    R′ = R′\r;
  else
    r = r + 1;
  end if
end while
```

It should be noted that, N_{PDSCH}^{repeat,max} may be the maximum of pdsch-AggregationFactor and pdsch-AggregationFactor-r16. It should be noted that, in the embodiments of the disclosure, n_{0,k} and n_{0,k} and [(n_{U}−K_{1,k})·2^{μ}^{_{DL}}^{-μ}^{_{UL}}] may be used interchangeably.

It should be noted that, in the embodiments of the disclosure, “the UE is not configured with a parameter with respect to PDSCH transmission with repetitions” may be replaced with “the UE is not configured to monitor DCI format 1_2”, and “the UE is configured with a parameter with respect to PDSCH transmission with repetitions” may be replaced with “the UE is configured to monitor DCI format 1_2”.

The method can avoid that there is no corresponding bit position in the HARQ-ACK codebook for PDSCH repetition transmission when PDSCH repetition transmission and PDSCH bundling are configured at the same time, and can improve the reliability of the HARQ-ACK codebook.

In an example, for a serving cell c, an active downlink BWP, and an active uplink BWP, the UE determines a set of M_{A,c} occasions for candidate PDSCH receptions for which the UE transmits corresponding HARQ-ACK information in a PUCCH in uplink slot n_{U}. For a set of slot timing values K1, the UE may determine the set of M_{A,c} occasions according to pseudo code-3 of table 5.

TABLE 5
[Pseudo code−3]

```
Set j = 0 - index of occasion for candidate PDSCH reception or SPS PDSCH release or
TCI state update
Set B = Ø
Set M_{A,c} = Ø
Set [symbol] (K₁) to the cardinality of set K₁
Set k = 0 - index of slot timing values K_{1,k}, in descending order of the slot timing values,
in Set K₁ for serving cell c
if a UE is not configured with a carrier aggregation slot offset parameter (e.g., 3GPP
parameter ca-SlotOffset) for any serving cell of PDSCH receptions and PUCCH (e.g.,
PUCCH containing HARQ-ACK information) transmissions
while k < [symbol] (K₁)
if mod (n_{U} − K_{1,k} + 1, max(2^{μ}^{_{UL}}^{-μ}^{_{DL}}, 1)) = 0 or the subslot length parameter is
  configured for the HARQ-ACK codebook (e.g., the UE is configured with 3GPP
  parameter subslotLengthForPUCCH)
  Set n_{D} = 0 - index of a downlink slot overlapping with an uplink slot (index of a
    downlink slot within an uplink slot), e.g., uplink slot n_{U} − K_{1,k}
  Set Nₖ to a number of downlink slots overlapping with uplink slot n_{U} − K_{1,k} if the
    subslot length parameter is configured for the HARQ-ACK codebook; otherwise
    (no subslot length parameter is configured for the HARQ-ACK codebook), Nₖ =
    max(2^{μ}^{_{DL}}^{-μ}^{_{UL}}, 1)
  while n_{D} < Nₖ
    if a parameter with respect to time domain resource allocation for multiple
    PDSCHs (e.g., PDSCH-TimeDomainResourceAllocationListForMultiPDSCH)
    and a parameter with respect to enabling of time domain HARQ bundling (e.g.,
    3GPP parameter enableTimeDomainHARQ-Bundling) are configured for serving
    cell c
      R = R_{T};
      R′ = R_{T}′;
    elseif the parameter with respect to time domain resource allocation for multiple
    PDSCHs (e.g., PDSCH-TimeDomainResourceAllocationListForMultiPDSCH) is
    configured and the parameter with respect to enabling of time domain HARQ
    bundling (e.g., 3GPP parameter enableTimeDomainHARQ-Bundling) is not
    configured for serving cell c
      R = R_{T};
    else
      Set R to the set of rows, e.g., the set of rows configured by a TDRA table
    end if
    Set [symbol] (R) to the cardinality of set R
    Set r = 0 - index of row in set R
    if slot n_{U} starts at a same time as or after a slot (or time) for an active downlink
    BWP change on serving cell c or an active uplink BWP change on the PCell and
    slot n_{0,k} + n_{D} is before the slot (or time) for the active downlink BWP change on
    serving cell c or the active uplink BWP change on the PCell, or the subslot
    length parameter is configured for the HARQ-ACK codebook and downlink slot
    n_{0,k} + n_{D} overlaps with uplink slot n_{U} − K_{1,k-1}, k > 0, where slot n_{0,k} is a
    downlink slot with a smallest index among downlink slots overlapping with
    uplink slot n_{U} − K_{1,k} (or in uplink slot n_{U} − K_{1,k}),
      n_{D} = n_{D} + 1;
    else
      while r < [symbol] (R)
        if the UE is not configured with the parameter with respect to enabling of
        time domain HARQ bundling (e.g., 3GPP parameter
        enableTimeDomainHARQ-Bundling) and is configured with tdd-UL-DL-
        ConfigurationCommon, or tdd-UL-DL-ConfigurationDedicated and, for
        each slot from slot n_{0,k} + n_{D} − N_{PDSCH}^{repeat,max} + 1 to slot n_{0,k} + n_{D}, at least
        one symbol of the PDSCH time domain resource corresponding to row r is
        configured as uplink where K_{1,k} is the k-th slot timing value in set K₁,
        where slot n_{0,k} is a downlink slot with a smallest index among downlink
        slots overlapping with uplink slot n_{U} − K_{1,k} (or in uplink slot n_{U} − K_{1,k}),
        or, if the subslot length parameter is configured for the HARQ-ACK
        codebook and the end of the PDSCH time domain resource corresponding to
        row r is not within any uplink slot n_{U} − K_{1,l}, where 0 ≤ l < [symbol] (K₁),
        or, HARQ-ACK information for PDSCH corresponding to row r in slot
        n_{0,k} + n_{D} (or slot └(n_{U} − K_{1,k}) · 2^{μ}^{_{DL}}^{-μ}^{_{UL}}┘ + n_{D}) cannot be reported (or
        transmitted, or provided) in slot n_{U} (e.g., the UE is configured with
        scheduling of multiple PDSCHs (e.g., the UE is configured with 3GPP
        parameter PDSCH-TimeDomainResourceAllocationListForMultiPDSCH)
          R = R\r;
        elseif the UE is configured with the parameter with respect to enabling of
        time domain HARQ bundling (e.g., 3GPP parameter
        enableTimeDomainHARQ-Bundling) and the UE is configured with tdd-UL-
        DL-ConfigurationCommon, or tdd-UL-DL-ConfigurationDedicated, and the
        UE is not configured with the parameter with respect to PDSCH
        transmission with repetitions (e.g., 3GPP parameter pdsch-
        AggregationFactor and/or pdsch-AggregationFactor-r16), for each slot in
        slot n_{0,k} + n_{D} − ΔK_{0,r}(d) (or slot └(n_{U} − K_{1,k}) · 2^{μ}^{_{DL}}^{-μ}^{_{UL}}┘ + n_{D} −
        ΔK_{0,r}(d)), at least one symbol of the PDSCH time domain resource
        corresponding to row r of set R′ is configured as uplink, where K_{1,k} is
        the k-th slot timing value in set K₁, slot n_{0,k} is a downlink slot with a
        smallest index among downlink slots overlapping with uplink slot n_{U} −
        K_{1,k} (or in uplink slot n_{U} − K_{1,k}), ΔK_{0,r}(d) is the difference between the
        maximum value of K₀ in row r and K₀ of the element with an index d (e.g.,
        $Δ {K}_{0 , r} = {max}_{{K}_{0}} ( {K}_{0 , r} ) - {K}_{0 , r} ) , d = 0 , 1 , … , 𝒞 ( Δ {K}_{0 , r} ) - 1 , where 𝒞 ( Δ {K}_{0 , r} ) is the$
        cardinality of ΔK_{0,r}(d).
          R = R\r;
          R′ = R′\r;
        elseif the UE is configured with the parameter with respect to enabling of
        time domain HARQ bundling (e.g., 3GPP parameter
        enableTimeDomainHARQ-Bundling) and the UE is configured with tdd-UL-
        DL-ConfigurationCommon, or tdd-UL-DL-ConfigurationDedicated, and the
        UE is configured with the parameter with respect to PDSCH transmission
        with repetitions (e.g., 3GPP parameter pdsch-AggregationFactor and/or
        pdsch-AggregationFactor-r16), for each slot in slot n_{0,k} + n_{D} − ΔK_{0,r}(d)
        (or slot └(n_{U} − K_{1,k}) . 2^{μ}^{_{DL}}^{-μ}^{_{UL}} + n_{D} − ΔK_{0,r}(d)), at least one symbol of
        the PDSCH time domain resource corresponding to row r of set R′ is
        configured as uplink, and for each slot from slot n_{0,k} + n_{D} − N_{PDSCH}^{repeat,max} +
        1 to slot n_{0,k} + n_{D}, at least one symbol of the PDSCH time domain
        resource corresponding to row r of set R is configured as uplink, where
        K_{1,k} is the k-th slot timing value in set K₁, slot n_{0,k} is a downlink slot with
        a smallest index among downlink slots overlapping with uplink slot n_{U} −
        K_{1,k} (or in uplink slot n_{U} − K_{1,k}), ΔK_{0,r}(d) is the difference between the
        maximum value of K₀ in row r and K₀ of the element with an index d (e.g.,
        $Δ {K}_{0 , r} = {max}_{{K}_{0}} ( {K}_{0 , r} ) - {K}_{0 , r} ) , d = 0 , 1 , … , 𝒞 ( Δ {K}_{0 , r} ) - 1 , where 𝒞 ( Δ {K}_{0 , r} ) is the$
        cardinality of ΔK_{0,r}(d).
          R = R\r;
          R′ = R′\r;
        else
          r = r + 1;
        end if
      end while
      if the UE does not indicate a capability to receive more than one unicast
      PDSCH or multicast PDSCH per slot and R ≠ Ø,
        M_{A,c} = M_{A,c} ∪ j;
        j = j + 1;
      else
        Set [symbol] (R) to the cardinality of set R
        Set m to the smallest last OFDM symbol index, as determined by the SLIV,
        among all rows of R
        while R ≠ Ø
          Set r = 0
          while r < [symbol] (R)
            if S ≤ m for starting symbol index S for row r
            b_{r,kn}_{_{D}} = j; - index of occasion for candidate PDSCH reception, or
            SPS PDSCH release, or TCI state update for row r
            R = R\r;
              B = B ∪ b_{r,kn}_{_{D}};
            else
              r = r + 1;
            end if
          end while
          M_{A,c} = M_{A,c} ∪ j
          j = j + 1;
          Set m to the smallest last OFDM symbol index among all rows of R;
        end while
      end if
      n_{D} = n_{D} + 1;
    end if
    end while
  end if
  k = k + 1;
end while
else
while k < [symbol] (K₁)
        $If mod ( {n}_{U} - {K}_{1 , k} + ⌊ ( \frac{{N}_{slot , offset}^{UL}}{{2}^{{μ}_{offset , UL}}} - \frac{{N}_{slot , offset , c}^{DL}}{{2}^{{μ}_{offset , DL , c}}} ) \cdot {2}^{{μ}_{UL}} ⌋ + 1 , max ( {2}^{{μ}_{UL} - {μ}_{DL}} , 1 ) ) = 0$
          or the subslot length parameter is configured for the HARQ-ACK codebook (e.g., the
          UE is configured with 3GPP parameter subslotLengthForPUCCH)
          Set n_{D} = 0 - index of a downlink slot overlapping with an uplink slot (index of a
            downlink slot within an uplink slot), e.g., uplink slot n_{U} − K_{1,k}
          Set Nₖ to a number of downlink slots overlapping with uplink slot n_{U} − K_{1,k} if the
            subslot length parameter is configured for the HARQ-ACK codebook; otherwise
            (no subslot length parameter is configured for the HARQ-ACK codebook), Nₖ =
            max(2^{μ}^{_{DL}}^{-μ}^{_{UL}}, 1)
          while n_{D} < Nₖ
          if the parameter with respect to time domain resource allocation for multiple
          PDSCHs (e.g., PDSCH-TimeDomainResourceAllocationListForMultiPDSCH)
          and the parameter with respect to enabling of time domain HARQ bundling (e.g.,
          3GPP parameter enableTimeDomainHARQ-Bundling) are configured for serving
          cell c
            R = R_{T};
            R′ = R′_{T};
          elseif the parameter with respect to time domain resource allocation for multiple
          PDSCHs (e.g., PDSCH-TimeDomainResourceAllocationListForMultiPDSCH) is
          configured and the parameter with respect to enabling of time domain HARQ
          bundling (e.g., 3GPP parameter enableTimeDomainHARQ-Bundling) is not
          configured for serving cell c
            R = R_{T};
          else
            Set R to the set of rows, e.g., the set of rows configured by a TDRA table
          end if
          Set [symbol] (R) to the cardinality of set R
          Set r = 0 - index of row in set R
          if slot n_{U} starts at a same time as or after a slot (or time) for an active downlink
          BWP change on serving cell c or an active uplink BWP change on the PCell and
          slot n_{0,k} + n_{D} is before the slot (or time) for the active downlink BWP change on
          serving cell c or the active uplink BWP change on the PCell, or the subslot
          length parameter is configured for the HARQ-ACK codebook and downlink slot
          n_{0,k} + n_{D} overlaps with uplink slot n_{U} − K_{1,k-1}, k > 0, where slot n₀,ₖ is a
          downlink slot with a smallest index among downlink slots overlapping with
          uplink slot n_{U} − K_{1,k} (or in uplink slot n_{U} − K_{1,k}),
            n_{D} = n_{D} + 1;
          else
            while r < [symbol] (R)
          if the UE is not configured with the parameter with respect to enabling of
          time domain HARQ bundling (e.g., 3GPP parameter
          enableTimeDomainHARQ-Bundling) and is configured with tdd-UL-DL-
          ConfigurationCommon, or tdd-UL-DL-ConfigurationDedicated and, for
          each slot from slot n_{0,k} + n_{D} − N_{PDSCH}^{repeat,max} + 1 to slot n_{0,k} + n_{D}, at least
          one symbol of the PDSCH time domain resource corresponding to row r is
          configured as uplink where K_{1,k} is the k-th slot timing value in set K₁,
          where slot n_{0,k} is a downlink slot with a smallest index among downlink
          slots overlapping with uplink slot n_{U} − K_{1,k} (or in uplink slot n_{U} − K_{1,k}),
          or, if the subslot length parameter is configured for the HARQ-ACK
          codebook and the end of the PDSCH time domain resource corresponding to
          row r is not within any uplink slot n_{U} − K_{1,l}, where 0 ≤ l < [symbol] (K₁),
          or, HARQ-ACK information for PDSCH corresponding to row r in slot
          n_{0,k} + n_{D} (or slot └(n_{U} − K_{1,k}) · 2^{μ}^{_{DL}}^{-μ}^{_{UL}}┘ + n_{D}) cannot be reported (or
          transmitted, or provided) in slot n_{U} (e.g., the UE is configured with
          scheduling of multiple PDSCHs (e.g., the UE is configured with 3GPP
          parameter PDSCH-TimeDomainResourceAllocationListForMultiPDSCH)
            R = R\r;
          elseif the UE is configured with the parameter with respect to enabling of
          time domain HARQ bundling (e.g., 3GPP parameter
          enableTimeDomainHARQ-Bundling) and the UE is configured with tdd-UL-
          DL-ConfigurationCommon, or tdd-UL-DL-ConfigurationDedicated, and the
          UE is not configured with the parameter with respect to PDSCH
          transmission with repetitions (e.g., 3GPP parameter pdsch-
          AggregationFactor and/or pdsch-AggregationFactor-r16), for each slot in
          slot n_{0,k} + n_{D} − ΔK_{0,r}(d) (or slot └(n_{U} − K_{1,k}) · 2^{μ}^{_{DL}}^{-μ}^{_{UL}}┘ + n_{D} −
          ΔK_{0,r}(d)), at least one symbol of the PDSCH time domain resource
          corresponding to row r of set R′ is configured as uplink, where K_{1,k} is
          the k-th slot timing value in set K₁, slot n_{0,k} is a downlink slot with a
          smallest index among downlink slots overlapping with uplink slot n_{U} −
          K_{1,k} (or in uplink slot n_{U} − K_{1,k}), ΔK_{0,r}(d) is the difference between the
          maximum value of K₀ in row r and K₀ of the element with an index d (e.g.,
          $Δ {K}_{0 , r} = {max}_{{K}_{0}} ( {K}_{0 , r} ) - {K}_{0 , r} ) , d = 0 , 1 , … , 𝒞 ( Δ {K}_{0 , r} ) - 1 , where 𝒞 ( Δ {K}_{0 , r} ) is the$
          cardinality of ΔK_{0,r}(d).
            R = R\r;
            R′ = R′\r;
          elseif the UE is configured with the parameter with respect to enabling of
          time domain HARQ bundling (e.g., 3GPP parameter
          enableTimeDomainHARQ-Bundling) and the UE is configured with tdd-UL-
          DL-ConfigurationCommon, or tdd-UL-DL-ConfigurationDedicated, and the
          UE is configured with the parameter with respect to PDSCH transmission
          with repetitions (e.g., 3GPP parameter pdsch-AggregationFactor and/or
          pdsch-AggregationFactor-r16), for each slot in slot n_{0,k} + n_{D} − ΔK_{0,r}(d)
          (or slot └(n_{U} − K_{1,k}) · 2^{μ}^{_{DL}}^{-μ}^{_{UL}}┘ + n_{D} − ΔK_{0,r}(d)), at least one symbol of
          the PDSCH time domain resource corresponding to row r of set R′ is
          configured as uplink, and for each slot from slot n_{0,k} + n_{D} − N_{PDSCH}^{repeat,max} +
          1 to slot n_{0,k} + n_{D}, at least one symbol of the PDSCH time domain
          resource corresponding to row r of set R is configured as uplink, where
          K_{1,k} is the k-th slot timing value in set K₁, slot n_{0,k} is a downlink slot with
          a smallest index among downlink slots overlapping with uplink slot n_{U} −
          K_{1,k} (or in uplink slot n_{U} − K_{1,k}), ΔK_{0,r}(d) is the difference between the
          maximum value of K₀ in row r and K₀ of the element with an index d (e.g.,
          $Δ {K}_{0 , r} = {max}_{{K}_{0}} ( {K}_{0 , r} ) - {K}_{0 , r} ) , d = 0 , 1 , … , 𝒞 ( Δ {K}_{0 , r} ) - 1 , where 𝒞 ( Δ {K}_{0 , r} ) is the$
          cardinality of ΔK_{0,r}(d).
            R = R\r;
            R′ = R′\r;
          else
            r = r + 1;
          end if
        end while
        if the UE does not indicate a capability to receive more than one unicast
        PDSCH or multicast PDSCH per slot and R ≠ Ø,
          M_{A,c} = M_{A,c} ∪ j;
          j = j + 1;
        else
          Set [symbol] (R) to the cardinality of set R
          Set m to the smallest last OFDM symbol index, as determined by the SLIV,
          among all rows of R
          while R ≠ Ø
            Set r = 0
            while r < [symbol] (R)
              if S ≤ m for starting symbol index S for row r
                b_{r,knD} = j; - index of occasion for candidate PDSCH reception, or
                SPS PDSCH release, or TCI state update for row r
                R = R\r;
                B = B ∪ b_{r,k,n}_{_{D}};
              else
                r = r + 1;
              end if
            end while
            M_{A,c} = M_{A,c} ∪ j
            j = j+ 1;
            Set m to the smallest last OFDM symbol index among all rows of R;
          end while
        end if
        n_{D} = n_{D} + 1;
      end if
    end while
  end if
  k = k + 1;
end while
end if
```

It should be noted that pseudo code-1 in pseudo code-3 of table 5 may be replaced with pseudo code-2 of table 4.

In some implementations, the method 800 may include transmitting the PUSCH and/or receiving the PDSCH based on one or more of the manners MN1˜MN16 described above.

In some implementations, the method 800 may include the methods or operations that may be performed by the terminal (e.g., UE) in various embodiments described above.

FIG. 9 illustrates a block diagram of a first transceiving node 900 according to embodiments of the invention.

Referring to FIG. 9, the first transceiving node 900 may include a transceiver 901 and a controller 902.

The transceiver 901 may be configured to transmit first data and/or first control signaling to a second transceiving node and receive second data and/or second control signaling from the second transceiving node in a time unit.

The controller 902 may be an application specific integrated circuit or at least one processor. The controller 902 may be configured to control the overall operation of the first transceiving node, including controlling the transceiver 901 to transmit the first data and/or the first control signaling to the second transceiving node and receive the second data and/or the second control signaling from the second transceiving node in a time unit.

In some implementations, the controller 902 may be configured to perform one or more of operations in the methods of various embodiments described above.

In the following description, a base station is taken as an example (but not limited thereto) to illustrate the first transceiving node, a UE is taken as an example (but not limited thereto) to illustrate the second transceiving node. Downlink data and/or downlink control signaling (but not limited thereto) are used to illustrate the first data and/or the first control signaling. A HARQ-ACK codebook may be included in the second control signaling, and uplink control signaling (but not limited thereto) is used to illustrate the second control signaling.

FIG. 10 illustrates a flowchart of a method 1000 performed by a base station according to an embodiment of the invention.

Referring to FIG. 10, in step S1010, the base station transmits downlink data and/or downlink control information.

In step S1020, the base station receives second data and/or second control information from a UE in a time unit.

For example, the method 1000 may include one or more of the operations performed by the base station described in various embodiments of the disclosure.

FIG. 11 illustrates a block diagram of a terminal (or a user equipment (UE)), according to embodiments of the present disclosure.

As shown in FIG. 11, a terminal according to an embodiment may include a transceiver 1110, a memory 1120, and a processor (or a controller) 1130. The transceiver 1110, the memory 1120, and the processor (or controller) 1130 of the terminal may operate according to a communication method of the terminal described above. However, the components of the terminal are not limited thereto. For example, the terminal may include more or fewer components than those described in FIG. 11. In addition, the processor (or controller) 1130, the transceiver 1110, and the memory 1120 may be implemented as a single chip. Also, the processor (or controller) 1130 may include at least one processor.

The transceiver 1110 collectively refers to a terminal station receiver and a terminal transmitter, and may transmit/receive a signal to/from a base station or another terminal. The signal transmitted or received to or from the terminal may include control information and data. The transceiver 1110 may include a RF transmitter for up-converting and amplifying a frequency of a transmitted signal, and a RF receiver for amplifying low-noise and down-converting a frequency of a received signal. However, this is only an example of the transceiver 1110 and components of the transceiver 1110 are not limited to the RF transmitter and the RF receiver.

Also, the transceiver 1110 may receive and output, to the processor (or controller) 1130, a signal through a wireless channel, and transmit a signal output from the processor (or controller) 1130 through the wireless channel.

The memory 1120 may store a program and data required for operations of the terminal. Also, the memory 1120 may store control information or data included in a signal obtained by the terminal. The memory 1120 may be a storage medium, such as read-only memory (ROM), random access memory (RAM), a hard disk, a CD-ROM, and a DVD, or a combination of storage media.

The processor (or controller) 1130 may control a series of processes such that the terminal operates as described above. For example, the processor (or controller) 1130 may receive a data signal and/or a control signal, and the processor (or controller) 1130 may determine a result of receiving the signal transmitted by the base station and/or the other terminal.

FIG. 12 illustrates a block diagram of a base station, according to embodiments of the present disclosure.

As shown in FIG. 12 is, the base station of the present disclosure may include a transceiver 1210, a memory 1220, and a processor (or, a controller) 1230. The transceiver 1210, the memory 1220, and the processor (or controller) 1230 of the base station may operate according to a communication method of the base station described above. However, the components of the base station are not limited thereto. For example, the base station may include more or fewer components than those described in FIG. 12. In addition, the processor (or controller) 1230, the transceiver 1210, and the memory 1220 may be implemented as a single chip. Also, the processor (or controller) 1230 may include at least one processor.

The transceiver 1210 collectively refers to a base station receiver and a base station transmitter, and may transmit/receive a signal to/from a terminal, another base station, and/or a core network function(s) (or entity(s)). The signal transmitted or received to or from the base station may include control information and data. The transceiver 1210 may include a RF transmitter for up-converting and amplifying a frequency of a transmitted signal, and a RF receiver for amplifying low-noise and down-converting a frequency of a received signal. However, this is only an example of the transceiver 1210 and components of the transceiver 1210 are not limited to the RF transmitter and the RF receiver.

Also, the transceiver 1210 may receive and output, to the processor (or controller) 1230, a signal through a wireless channel, and transmit a signal output from the processor (or controller) 1230 through the wireless channel.

The memory 1220 may store a program and data required for operations of the base station. Also, the memory 1220 may store control information or data included in a signal obtained by the base station. The memory 1220 may be a storage medium, such as ROM, RAM, a hard disk, a CD-ROM, and a DVD, or a combination of storage media.

The processor (or controller) 1230 may control a series of processes such that the base station operates as described above. For example, the processor (or controller) 1230 may receive a data signal and/or a control signal, and the processor (or controller) 1230 may determine a result of receiving the signal transmitted by the terminal and/or the core network function.

The methods according to the embodiments described in the claims or the detailed description of the present disclosure may be implemented in hardware, software, or a combination of hardware and software.

When the electrical structures and methods are implemented in software, a computer-readable recording medium having one or more programs (software modules) recorded thereon may be provided. The one or more programs recorded on the computer-readable recording medium are configured to be executable by one or more processors in an electronic device. The one or more programs include instructions to execute the methods according to the embodiments described in the claims or the detailed description of the present disclosure.

Those skilled in the art will understand that the above illustrative embodiments are described herein and are not intended to be limiting. It should be understood that any two or more of the embodiments disclosed herein may be combined in any combination. Furthermore, other embodiments may be utilized and other changes may be made without departing from the spirit and scope of the subject matter presented herein. It will be readily understood that aspects of the invention of the disclosure as generally described herein and shown in the drawings may be arranged, replaced, combined, separated and designed in various different configurations, all of which are contemplated herein.

Those skilled in the art will understand that the various illustrative logical blocks, modules, circuits, and steps described in this application may be implemented as hardware, software, or a combination of both. To clearly illustrate this inter-changeability between hardware and software, various illustrative components, blocks, modules, circuits, and steps are generally described above in the form of their functional sets. Whether such function sets are implemented as hardware or software depends on the specific application and the design constraints imposed on the overall system. Technicians may implement the described functional sets in different ways for each specific application, but such design decisions should not be interpreted as causing a departure from the scope of this application.

The various illustrative logic blocks, modules, and circuits described in this application may be implemented or performed by a general purpose processor, a Digital Signal Processor (DSP), an Application Specific Integrated Circuit (ASIC), a Field Programmable Gate Array (FPGA) or other programmable logic devices, discrete gates or transistor logics, discrete hardware components, or any combination thereof designed to perform the functions described herein. The general purpose processor may be a microprocessor, but in an alternative, the processor may be any conventional processor, controller, microcontroller, or state machine. The processor may also be implemented as a combination of computing devices, such as a combination of a DSP and a microprocessor, a plurality of microprocessors, one or more microprocessors cooperating with a DSP core, or any other such configuration.

The steps of the method or algorithm described in this application may be embodied directly in hardware, in a software module executed by a processor, or in a combination thereof. The software module may reside in RAM memory, flash memory, ROM memory, EPROM memory, EEPROM memory, register, hard disk, removable disk, or any other form of storage medium known in the art. An exemplary storage medium is coupled to a processor to enable the processor to read and write information from/to the storage media. In an alternative, the storage medium may be integrated into the processor. The processor and the storage medium may reside in an ASIC. The ASIC may reside in a user terminal. In an alternative, the processor and the storage medium may reside in the user terminal as discrete components.

In one or more exemplary designs, the functions may be implemented in hardware, software, firmware, or any combination thereof. If implemented in software, each function may be stored as one or more pieces of instructions or codes on a computer-readable medium or delivered through it. The computer-readable medium includes both a computer storage medium and a communication medium, the latter including any medium that facilitates the transfer of computer programs from one place to another. The storage medium may be any available medium that can be accessed by a general purpose or special purpose computer.

The above description is only an exemplary implementation of the present invention, and is not intended to limit the scope of protection of the present invention, which is determined by the appended claims.

1. A method performed by a terminal in a wireless communication system, the method comprising:
receiving, from a base station, first information configuring a time domain allocation list for multiple physical downlink shared channels (PDSCHs) and second information enabling a time domain hybrid automatic repeat request (HARQ) bundling;
receiving, from the base station, a plurality of PDSCHs; and
transmitting, to the base station, a HARQ acknowledgement (HARQ-ACK) codebook for the plurality of PDSCHs based on the first information and the second information,
wherein, in case that each slot of the plurality of PDSCHs includes an uplink symbol of a PDSCH time resource, a time domain resource allocation set for the HARQ-ACK codebook is updated based on a row index corresponding to the PDSCH time resource.

2. The method of claim 1, wherein the time domain resource allocation set includes a first set including PDSCH time domain resource allocation tables and a second set including last start and length indicator value (SLIV) of each row of the first set.

3. The method of claim 1, wherein the plurality of PDSCHs are received in a plurality of downlink slots overlapping with an uplink slot, starting from a smallest index.

4. The method of claim 1, wherein the HARQ-ACK codebook for the plurality of PDSCHs is generated based on the first information, the second information, and third information configuring the HARQ-ACK codebook as semi-static, and
wherein the uplink symbol is configured by a time division duplex (TDD) uplink downlink configuration for the terminal.

5. A method performed by a base station in a wireless communication system, the method comprising:
transmitting, to a terminal, first information configuring a time domain allocation list for multiple physical downlink shared channels (PDSCHs) and second information enabling a time domain hybrid automatic repeat request (HARQ) bundling;
transmitting, to the terminal, a plurality of PDSCHs; and
receiving, from the terminal, a HARQ acknowledgement (HARQ-ACK) codebook for the plurality of PDSCHs based on the first information and the second information,
wherein, in case that each slot of the plurality of PDSCHs includes an uplink symbol of a PDSCH time resource, a time domain resource allocation set for the HARQ-ACK codebook is updated based on a row index corresponding to the PDSCH time resource.

6. The method of claim 5, wherein the time domain resource allocation set includes a first set including PDSCH time domain resource allocation tables and a second set including last start and length indicator value (SLIV) of each row of the first set.

7. The method of claim 5, wherein the plurality of PDSCHs are transmitted in a plurality of downlink slots overlapping with an uplink slot, starting from a smallest index, wherein the HARQ-ACK codebook for the plurality of PDSCHs is based on the first information, the second information, and third information configuring the HARQ-ACK codebook as semi-static, and wherein the uplink symbol is configured by a time division duplex (TDD) uplink downlink configuration for the terminal.

8. A terminal in a wireless communication system, the terminal comprising:
a transceiver; and
a controller coupled with the transceiver and configured to:
receive, from a base station, first information configuring a time domain allocation list for multiple physical downlink shared channels (PDSCHs) and second information enabling a time domain hybrid automatic repeat request (HARQ) bundling,
receive, from the base station, a plurality of PDSCHs, and transmit, to the base station, a HARQ acknowledgement (HARQ-ACK) codebook for the plurality of PDSCHs based on the first information and the second information,
wherein, in case that each slot of the plurality of PDSCHs includes an uplink symbol of a PDSCH time resource, a time domain resource allocation set for the HARQ-ACK codebook is updated based on a row index corresponding to the PDSCH time resource.

9. The terminal of claim 8, wherein the time domain resource allocation set includes a first set including PDSCH time domain resource allocation tables and a second set including last start and length indicator value (SLIV) of each row of the first set.

10. The terminal of claim 8, wherein the plurality of PDSCHs are received in a plurality of downlink slots overlapping with an uplink slot, starting from a smallest index.

11. The terminal of claim 8, wherein the HARQ-ACK codebook for the plurality of PDSCHs is generated based on the first information, the second information, and third information configuring the HARQ-ACK codebook as semi-static, and
wherein the uplink symbol is configured by a time division duplex (TDD) uplink downlink configuration for the terminal.

12. A base station in a wireless communication system, the base station comprising:
a transceiver; and
a controller coupled with the transceiver and configured to:
transmit, to a terminal, first information configuring a time domain allocation list for multiple physical downlink shared channels (PDSCHs) and second information enabling a time domain hybrid automatic repeat request (HARQ) bundling,
transmit, to the terminal, a plurality of PDSCHs, and receive, from the terminal, a HARQ acknowledgement (HARQ-ACK) codebook for the plurality of PDSCHs based on the first information and the second information,
wherein, in case that each slot of the plurality of PDSCHs includes an uplink symbol of a PDSCH time resource, a time domain resource allocation set for the HARQ-ACK codebook is updated based on a row index corresponding to the PDSCH time resource.

13. The base station of claim 12, wherein the time domain resource allocation set includes a first set including PDSCH time domain resource allocation tables and a second set including last start and length indicator value (SLIV) of each row of the first set.

14. The base station of claim 12, wherein the plurality of PDSCHs are transmitted in a plurality of downlink slots overlapping with an uplink slot, starting from a smallest index.

15. The base station of claim 12, wherein the HARQ-ACK codebook for the plurality of PDSCHs is based on the first information, the second information, and third information configuring the HARQ-ACK codebook as semi-static, and
wherein the uplink symbol is configured by a time division duplex (TDD) uplink downlink configuration for the terminal.
